(19) United States
(12) Patent Application Publication
(10) Pub. No.: US 2022/0388213 A1
(43) Pub. Date: Dec. 8, 2022

(54) MARKING METHODS AND ARRANGEMENTS

(71) Applicant: Digimarc Corporation, Beaverton, OR (US)

(72) Inventors: Tomas Filler, Beaverton, OR (US); Vojtech Holub, Lafayette, CO (US); Nicholas Anderson, Colorado Springs, CO (US)

(21) Appl. No.: 17/835,775

(22) Filed: Jun. 8, 2022

Related U.S. Application Data
(63) Continuation of application No. 17/681,262, filed on Feb. 25, 2022, now abandoned.
(60) Provisional application No. 63/265,146, filed on Dec. 8, 2021.
(60) Provisional application No. 63/154,394, filed on Feb. 26, 2021.

(51) Int. Cl. B29C 45/37; B23K 26/362; B65D 1/02

(52) U.S. Cl. CPC B29C 45/372; B23K 26/362; B65D 1/0207; B65D 2203/00; B29L 2031/7158

(57) ABSTRACT

2D code patterns, such as digital watermark patterns, are formed on plastic objects by injection molding. In some implementations, a marked cell of the code pattern is not formed by a single mark on the mold surface, but by multiple discrete marks. Such marks can be exceedingly small (e.g., 50 microns or less—smaller than the width of a human hair), yet the resulting code pattern on the molded object is still readable from a distance. The small scale of the marks assures that the code pattern does not detract from object aesthetics, while also speeding the mold-marking process. Style transfer networks are employed in some implementations. The detailed technologies facilitate digital marking and identification of a great number of consumer plastic objects, thereby aiding recovery of such objects for recycling. Many other features and arrangements are also detailed.

### RELATED APPLICATION DATA

This application is a continuation of application Ser. No. 17/681,262, filed Feb. 25, 2022, which claims priority to U.S. applications 63/265,146, filed Dec. 8, 2021, and 63/154,394, filed Feb. 26, 2021. These applications are incorporated by reference.

### BACKGROUND

Marking physical objects with digital watermarks, as taught in patent publications US20210299706 and WO2020186234, is gaining in popularity. However, adoption of such technology is sometimes slowed by prospective customers' misconception that digital watermarking impairs aesthetics of the marked objects. This misconception is due, in part, to literature analogizing digital watermarking with 2D barcodes. This simplistic analogy is sometimes helpful in describing watermark functionality, but customers recoil from the notion of marking their products anything like with 2D barcodes—which are widely regarded as unsightly.

It is thus desirable to mark objects with digital watermarks, without impairing object aesthetics, and to demonstrate same to prospective customers.

A further hindrance to widespread adoption of digital watermarks is that the molds used to produce such objects can require an extensive time to machine.

It is thus desirable to speed the mold machining needed to produce watermarked plastic objects.

Different aspects of the present technology address these and other drawbacks of the prior art, and provide additional advantages.

Patent documents EP2983885, WO2013165415, and US2013038936, concern molding plastic items with small scale features, e.g., for identification and anti-counterfeiting. The article by Dr.-Ing Simon Wurzbacher, Key to Purity of Recycled Resins, Kunststoffe International, September 2021, pp. 17-21, teaches use of injection molding to form digital watermark patterns on plastic consumer packaging. Patent documents WO2020186234 and WO2021195563 also mention use of injection molding to form digital watermark patterns on plastic packaging.

### BRIEF DESCRIPTION OF THE DRAWINGS

FIG. 1 shows a few cells of a 2D code pattern, such as a digital watermark pattern.

FIG. 2 shows how a single code cell can be divided into smaller sub-cells.

FIGS. 3A-3C show that a single code cell can be marked by an array of dots of other shapes.

FIGS. 4A-4C illustrate that not all sub-cells in a cell need to be marked.

FIGS. 5-7 show other arrangements by which a code cell can be marked.

FIGS. 8-16 show that a code cell can be marked by features of different sizes, shapes and marking depths.

FIG. 17 shows that a cell of a bitonal code can be marked with two types of marks, one being the absence of any mark, and the other comprising one or more marks.

FIG. 18 shows a different arrangement by which a cell of a bitonal code can be marked with two types of marks—here an array of marks (signaling a “0” state), and a mark that fills the cell region (signaling a “1” state).

FIG. 19 shows how marking of watermark cells can adapt to other features of imagery, in this example switching between the FIG. 17 arrangement and the FIG. 18 arrangement, depending on whether the background is black or white.

FIG. 20 shows a greyscale photograph after thresholding, yielding a bitonal rendering.

FIGS. 21 and 21A illustrate that different greyscale tones can be mapped to different bitonal spatial patterns.

FIG. 22 shows a greyscale photograph converted into a four-tone image.

FIGS. 22A-22D illustrate how different patterns can be used to render a single greyscale tone.

FIG. 23 shows marking patterns by which the four tones in FIG. 22 can be rendered in one of two states, conveying waxel data of “0” and “1.”

FIG. 24 illustrates that a continuous tone watermark can comprise a weighted combination of a reference signal component and an encoded payload component.

FIG. 25 shows different arrangements by which a mold can be shaped to form a digital watermark pattern on plastic.

FIGS. 26A and 26B show sample texture patterns.

FIGS. 27A and 27B show a commercially-available catalog of textures with which a mold can be marked.

FIG. 28 shows examples of style transfer, resulting from use of the Gatys method.

FIG. 29A shows an image of a leather-like pattern that can be used as a reference style image; FIG. 29B shows a continuous-tone watermark image; and FIG. 29C shows an output image produced by applying the style of FIG. 29A to the pattern of FIG. 29B using a style transfer neural network.

FIG. 30 is a flowchart of how a mold can be shaped in accordance with output from a style transfer neural network.

FIGS. 31A and 31B illustrate another method by which an input pattern can be processed to yield a watermark-conveying pattern.

FIG. 32 shows a variety of aesthetically-pleasing patterns that convey watermark signals and can be used to mark molding surfaces.

FIG. 33 shows that a digital watermark can be composed of cells each marked with an artwork pattern.

FIG. 34 shows that a digital watermark can be composed of cells variously marked with different ones of several different artwork patterns.

FIG. 35 shows how markings of watermark cells need not be confined to the interior of such cells.

FIG. 36 show that spacing of marks can vary within a watermark.

FIGS. 37A-37D depict 4×4 cell fragments of a 128×128 cell 2D code, using different marking patterns to express the information.

### DETAILED DESCRIPTION

Surfaces of injection molds can be laser-textured to form features that are just a few tens of microns in lateral dimension (e.g., 50 or 20 microns), and having depth dimensions that are still finer (e.g., single digit- and sub-micron depths). Due to the very small dimensions of such features, the laser milling action can occur very quickly. (Femtosecond-pulsed lasers are sometimes used.)

In some aspects of the technology, such rapid mold shaping is used to form 2D code patterns that are reciprocally-impressed on plastic objects produced from the molds. Despite the minute surface variations involved, applicant has found that such code patterns are nonetheless reliably readable from the resulting plastic objects—even from distances as great as 50 cm. The rapid milling of the mold surface reduces the time and expense of mold creation, and thereby reduces one of the impediments to more widespread coding of plastic objects, e.g., to increase recycling.

The degree to which a 2D code is conspicuous to human viewers depends on its feature scale. The extremely small features employed in certain aspects of the technology yield codes that are commensurately inconspicuous. This, too, reduces an impediment to widespread adoption of 2D coding on plastic objects.

Plastic beverage and food containers produced from such molds include patterned protrusions. In the prior art, patterned protrusions sometimes yielded a tactile effect like that of sand-paper. This effect is objectionable to some consumers, who are accustomed to smooth food and beverage containers. In accordance with aspects of the present technology, the protrusions can be made so small (e.g., 100 microns or less in height, and sometimes 20 or 5 microns or less) that they are unobjectionable (or even undetectable) to consumers.

Details of injection molding are not belabored here. As is familiar, plastic is heated and injected into a cavity usually defined by shaped metal surfaces. A pressure in excess of 10,000 PSI (e.g., 20,000 or more PSI) is typically applied to cause pressure-induced deformation of the plastic, forcing it to conform to the mold, including any features formed on the metal surface. The high pressure enables sub-micron features on the metal surface to thereby be reciprocally-formed on the surface of the resulting plastic item. The discussion that follows is focused on the metal surface, but it will be recognized that the noted attributes are also reflected in the surface of the molded plastic item.

A metal mold can be marked using various means, with laser-marking often being preferred. The marking can be in three dimensions: the two lateral dimensions of the metal surface (x and y), and also in the orthogonal dimension of the metal thickness, or depth (z).

In an illustrative implementation, a laser is focused to a beamwidth having a first dimension, which defines a first resolution parameter, and is steered to a particular (x,y) location on a steel surface by an optical or mechanical system, typically in increments that define a second resolution parameter. In this illustrative implementation, the first resolution parameter may be 18 microns and is set by laser optics. The second resolution parameter may be 800 nanometers and is set by a beam-steering arrangement. The laser marking system can effect essentially continuous control in the third dimension, by controlling the laser energy applied to a particular location (e.g., by controlling the interval of time a location is marked—which may be in the range of nano-, pico- or femto-seconds, the laser focus, and/or the laser power). Naturally, these figures are simply exemplary of one particular implementation and are not limiting.

In such illustrative implementation, the laser is steered to define marked cells of a 2D code. The code can be binary, so each cell is marked to have one of two states. In print, the states might be black and white. In metal, however, the laser deforms the surface to define the two different states. For example, a first cell may be marked to have a matte texture, while a second cell is left unmarked—leaving a smooth, specular metal surface. When a plastic item is molded against such steel surface, the plastic takes on a reciprocal impression. The plastic molded counterpart to the first cell has a matte finish, while the molded counterpart to the second cell has a smooth finish. When such plastic is illuminated for imaging, the first cell diffuses (scatters) the illumination, and the second cell reflects the illumination, producing contrasting responses that are depicted in the captured imagery—permitting the cells to be distinguished, and the code to be decoded.

Each cell of the code desirably has a width of less than 500 microns, and preferably has a width of 340 or 200 microns or less. One embodiment has cells of width 169 microns, plus or minus 15 microns (corresponding to a watermark at roughly 150 watermark elements, or “waxels,” per inch). Other embodiments have still smaller cells, such as 100, 50 or 25 microns.

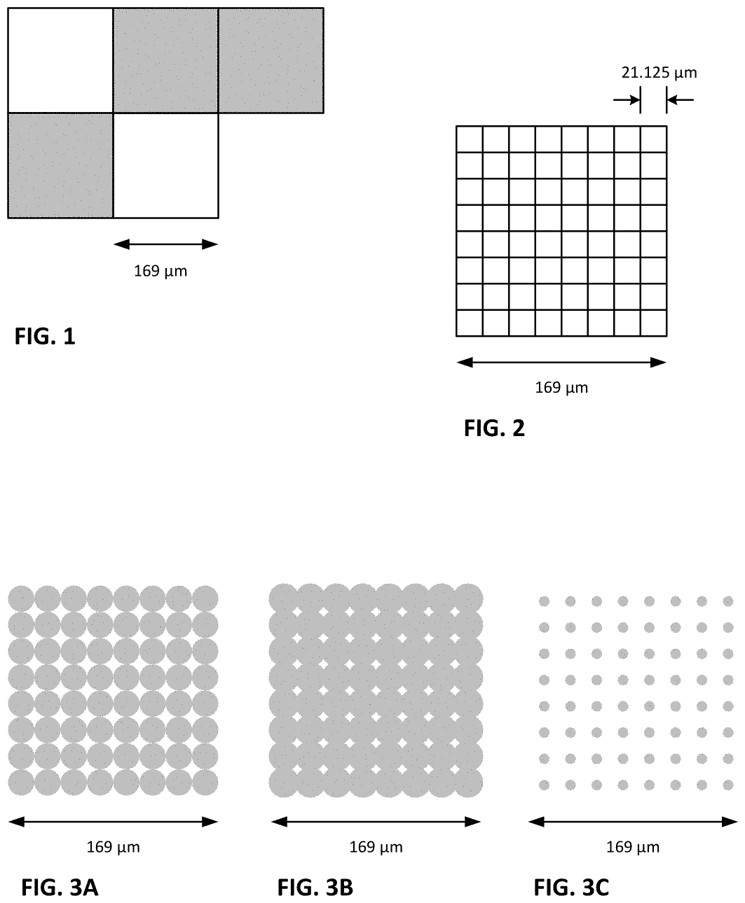

An excerpt of a binary code with cells of size 169 microns is shown in FIG. 1. The cells shown in grey denote cells that are surface textured to scatter incident light (e.g., matte finish). The cells shown in white denote cells that are untreated and retain the steel's original smooth surface finish, providing a more specular reflection of light.

In an illustrative arrangement, the steel's original smooth surface finish may have a roughness average of less than 2 microns, and more typically has a roughness of less than 1, 0.4, 0.1, 0.05 or 0.02 microns. The marked areas have a rougher finish. The greater the difference in finishes, the greater the visible contrasts between cells, and the more reliable is the decoding of the 2D code.

Some contrast can be achieved with a marked roughness that is just, e.g., 1.5 times the smooth surface roughness. Typically, larger contrast is desired, so marking to achieve roughness that is 2, 5, 10 or 20 or more times the original metal roughness may be used. In one example, the original surface roughness average is 0.3 microns, and the textured roughness is in the range of 0.6 to 3 microns. In another the original surface roughness is 0.1 microns, and the textured roughness is in the range 0.4 to 2 microns. These, of course, are just a few among countless variations. The guiding principle is contrast, with more contrast yielding more robust decoding.

(Surface roughness, sometimes termed Ra, or roughness average, may be regarded as the arithmetic average of the absolute values of profile height deviations from the mean of a line across the surface. A more precise mathematical definition is provided in ASME standard B46.1. A related but different measure, termed Rz, is the difference in elevation between the tallest “peaks” and the deepest “valleys” on a surface. The cited ASME standard again gives a mathematical definition.)

At some point, marked surface roughness goes beyond what might be regarded as a matte texture into a more distinct 3D shaping of the surface. This is a subjective distinction, but the transition might be regarded as somewhere between 3 and 20 microns, e.g., 5 or 10 microns. A 2D code can be formed in this 3D fashion, with the original metal surface at one level, and the marked metal cells being at a different, lower level—a step down from the original level. The base, or floor, of this stepped-down lower level is roughened by the marking (e.g., laser) action, and so is not as smooth as the original metal surface. Its surface roughness may be in the range of matte surfaces noted above, or greater. The average level of the floor differs from the average level of the original surface by, e.g., 3, 5, 10 or more microns. The textured surface of the floor can effect scattering of incident light, providing a contrast distinction to cells left unmarked, with their original metal finish. The depression of the marked cells introduces another optical effect, shadowing, that can further aid in producing visible contrast and helping code detection (i.e., the side walls of such stepped-down cells can shadow regions of the floor from incident light). Marking of such stepped-down cells, however, typically takes longer than forming a matte finish, and the larger 3D effect may be aesthetically undesirable in certain molded parts.

A further aspect of the present technology concerns marking code cells on metal surfaces of plastic injection molds to include multiple features. That is, instead of the entire area of a 2D code cell being marked, or a solitary feature within the cell being marked, multiple features are marked within the boundary of the cell, such as an array of isolated dots or other shapes. Each shape can be marked to have a light scattering feature (e.g., comprising a matte-like texture finish), as described above. Each shape in the cell (e.g., circles) may be regarded as being defined, in part, by a closed boundary within the cell where the shaped depression meets the nominal mold surface (i.e., its smooth, original surface prior to milling)—distinct from boundaries of other shapes in the cell.

To aid discussion, consider a single cell of a 2D code that is 169 microns on a side. Plural features can be marked within such a cell. FIG. 2 shows a virtual division of such a cell into an array of 64 sub-cells, each 21.125 microns on a side. Each of these sub-cells can be marked, e.g., by a laser forming a region of matte finish. The regions can be circular, as shown in FIG. 3A, and each can fill a sub-cell. Alternatively, each can be larger or smaller than a sub-cell, as shown in FIGS. 3B and 3C. Cells marked in such manner can be arrayed with unmarked cells to form contrasting elements of a binary 2D code. The matte-marked cells reflect incident light diffusely; the unmarked cells reflect light specularly. One can represent a binary “0” and the other can represent a binary “1.”

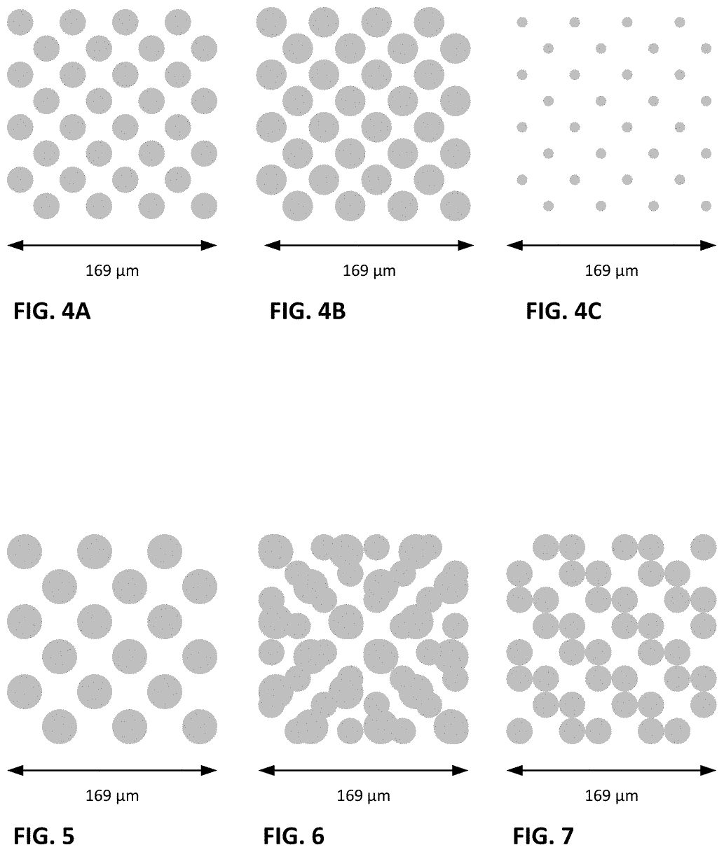

Not all of the illustrated 64 sub-cells need to be marked. For example, alternating sub-cells can be marked, yielding the checkerboard patterns of FIGS. 4A-4C. The total marked area of each of these cells is half that of the corresponding cells shown in FIG. 3A-3C. Thus, their diffuse reflection is halved, while their specular reflection is increased.

The features marked within a cell don't have to be centered in sub-cells of the 8×8 array shown in FIG. 2; they can be anywhere in the cell. FIG. 5 shows a checkerboard of round features within a 6×6 array. The markings can be symmetrical around a vertical axis, or symmetrical around a horizontal axis, or symmetrical around one or both diagonal axes, or combinations of those, or none of those. The markings can include features of different sizes. FIG. 6, for example, shows a cell resulting when the features of FIG. 4A and FIG. 5 are combined in a single cell. FIG. 7 shows still another arrangement.

Thus, one aspect of the present technology is a method that includes receiving data expressing a 2D machine readable code, including cells marked in at least first and second different states, where each cell has a width dimension less than 500 microns. A metal surface is then marked (e.g., laser-marked) with a pattern corresponding to the 2D machine readable code, where each cell of the code has a counterpart area on the metal surface. The method is characterized in that a first area corresponding to a single cell of the first state is marked with multiple features. This yields a light-diffusing effect. In some such implementations, a second area of the second state is left unmarked, yielding a light-reflecting effect. By such arrangement the first area appears of the mold surface to have a matte finish and the second area appears to have a specular finish. In some implementations, each of the marking features is isolated from the other marks.

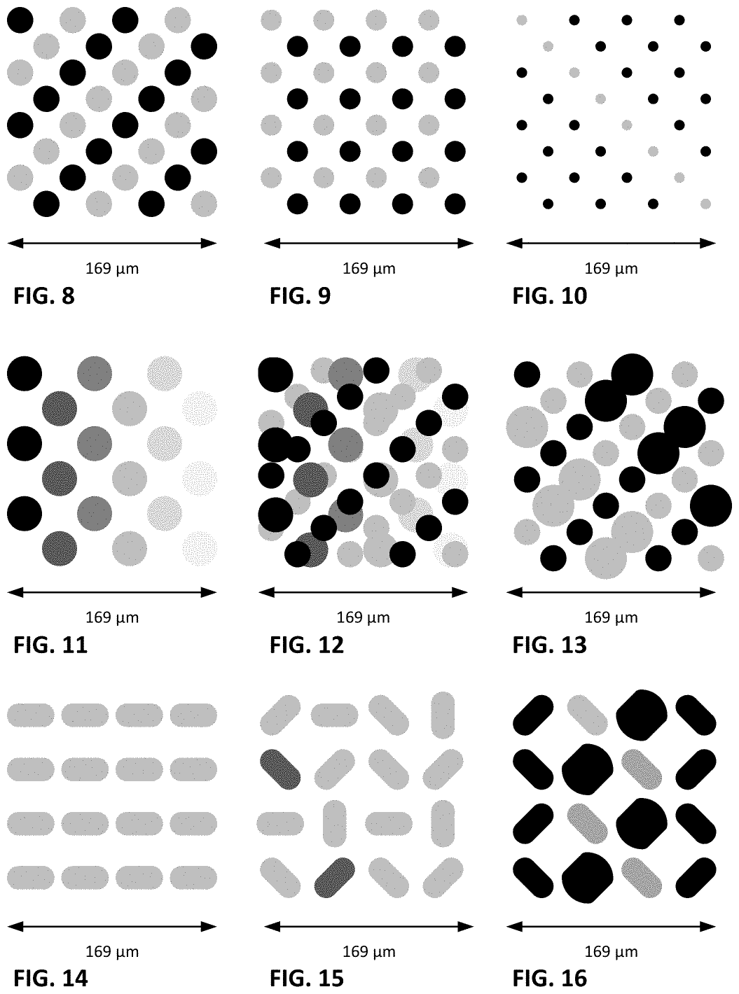

Different features within a cell can be marked with different effects, such as different surface roughnesses, or different step-down depths. FIGS. 8-10 show cells that include round matte-finished features, and round features that are stepped-down from the surface by, e.g., 10 microns (shown in black). Features having a range of different step-down depths can be used within a single cell, as shown by FIG. 11, where the darker graphics denotes deeper cavities (with the lightest grey showing matte finishing, which changes the average surface level by less than 3 microns.) Again, combinations employing features of different sizes and finishes/depths can be employed, as shown in FIGS. 12 and 13.

The marked features do not need to have round contours. For example, by moving a laser while energized, elongated features can be formed, as shown in FIG. 14. The speed of movement, laser focus and laser power can also be modulated to vary the feature characteristics. The features within a cell can have their primary axes oriented in two or more different directions, as shown in FIGS. 15 and 16. The features can also have random aspects, e.g., in orientation, size, and/or roughness/depth (as shown in FIG. 15).

Text, logos, and other bitonal graphics have been formed on a metal molding plates, in the prior art, by using different surface treatments to form visible differences. Patterned areas of matte-finishing, for example, can be applied to a metal surface to form text glyphs, which are then visibly distinct from the surrounding smooth metal (or vice versa).

In accordance with a further aspect of the present technology, text, logos and other bitonal graphics are formed on a metal surface of an injection mold using relatively smoother and rougher areas, but the relatively smoother areas are not uniformly-smooth, and the relatively rougher areas are not uniformly-textured. Rather, in a particular embodiment, each area comprises code cells that have one of two patterns, yielding four cell patterns in all. Typically, two or more of these patterns includes multiple features.

So doing exploits a feature of common watermark code detectors. Such detectors apply a high pass filter to the input imagery. Oct-axis filtering, e.g., as detailed in U.S. patent publications 20180005343 and 20150055837, is exemplary. Cells are then judged to represent “1” or “0” values not on their absolute appearances (e.g., based on absolute luminance of a cell's depiction in the captured imagery), but rather are judged based on their appearances relative to neighbors: is a cell relatively lighter than its neighborhood, or relatively darker? Based on such relative comparisons, a cell is interpreted to represent a “0” or “1.”

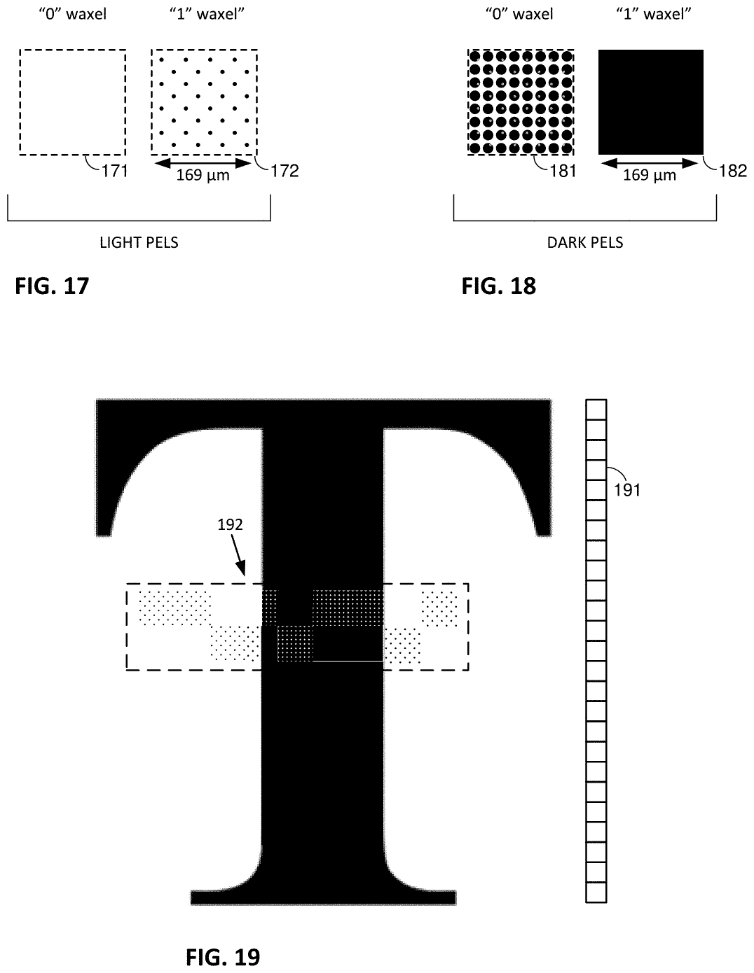

In smooth areas of the metal, the two cells may be as shown in FIG. 17. One cell (171) is smooth, while the other (172) includes a small degree of visible difference—such as by shaping to scatter a small degree of light (e.g., texture features of small size). One cell (e.g., cell 171) represents a “0” value and one cell (e.g., cell 172) represents a “1” value. Similarly, the contrasting areas may be as shown in FIG. 18. These cells 181, 182 are both marked to scatter light, but one (182) scatters more than the other (181). Again, one cell can represent a “0” value and cell 182 can represent a “1” value.

In text and logos, light and dark areas are not randomly scattered. On a micro basis (e.g., on the scale of a cell of a 150 element per inch watermark), dark cells are usually surrounded by other dark cells, and light cells are usually surrounded by other light cells. This enables the four cell varieties shown in FIGS. 17 and 18 to be used to signal two binary states. That is, the just-described filtering causes a dark cell within a darker region to be judged as a “0” or “1” in the context of dark cells nearby, while a lighter cell in a lighter region is judged as a “0” or “1” in the context of lighter cells nearby.

This is made clearer by FIG. 19. A metal mold surface is shaped so that the area within the outline of the T″ shape is visibly different than the area outside the T shape. Inside the dark “T” shape, the code cells of FIG. 18 are employed. Such cells are visually similar to each other, but different from the cells of FIG. 17. Yet the difference between the two different types of cells used within the area of the “T” shape can be discerned from camera imagery depicting an item molded by such plate, permitting recovery of code data from within the area of the “T.”

Similarly, outside the T shape the code cells of FIG. 17 can be employed. Again, such cells are similar to each other (one may be unmarked, and one may provide a relatively small degree of light scattering), but are different from the cells of FIG. 18. The difference between these cells, in the areas outside the area of the T shape, can be discerned from imagery of the item molded by such plate, again permitting recovery of code data.

For clarity of illustration, only 18 cells are detailed in FIG. 19 (within the dashed rectangle). In actual practice, most or all of the area of FIG. 19 would be edge-to-edge-tiled in cells of one of the four types shown in FIGS. 17 and 18, to represent the full 2D binary code.

Also for clarity of illustration, the 18 cells outlined by the dashed rectangle in FIG. 19 are shown as larger, in relationship to the text “T,” than is usually the case. If the “T” is sized at 12 point, then cells of a 150 cell per inch watermark would be of the size shown by the column of cells 191 to the right of the “T.”

In the FIG. 19 example, the tiled array of cells includes some cells that cross the light/dark boundary at the edge of the letter “T,” as shown at 192. The cells placed across such boundary can have portions that are differently-patterned, e.g., one side having the pattern of cell 171, and the other side having the pattern of cell 181, etc.

(It will be recognized that the detailed arrangement of patterned cells looks to mimic the “T,” with the darker-looking pair of cells 181, 182 used within the glyph, and the lighter-looking pair of cells 171, 172 used the glyph. But the FIG. 18 cells typically appear lighter to a camera than the FIG. 17 cells, because the former cells have a greater aggregate area of light scattering surface treatment—which diffuses light. The cells of FIG. 17, in contrast, are more nearly (or wholly) specular, so they reflect light. Depending on viewing position relative to illumination, specular surfaces most commonly look dark. No matter—what is important is the contrast. The marked surfaces can have inverted appearances (relatively-darker for lighter, and vice versa) depending on viewing circumstances.)

With attention, and adequate magnification, a human could discern from a molded plastic item the two different cell types that effect code patterning within the “T” of FIG. 19, and likewise outside. But the differences between the FIG. 18 cells comprising the T are small enough, and the differences between the FIG. 17 cells comprising the surrounding area are small enough, that they are not noticed in normal use of the item. (Recall that the sub-cell features that distinguish the cells 171 and 172 of FIG. 17 from each other are typically less than 100 microns in size—often much less. Similarly for the cells of FIG. 18.) Yet these small differences manifest as differences in pixel values in 8-bit (or 12-bit) camera imagery depicting an item shaped by the metal surface. (Typically, the imaging optics are arranged such that a single code cell on the item corresponds to about a single camera pixel.)

As indicated, corporate logos can be formed in this fashion. For example, an injection-molded plastic screw-on cap for a soda bottle can have what appears to be a bitonal representation of the soft drink company logo. In fact, dark portions the logo graphic comprise arrays of the two cells shown in FIG. 18, and surrounding light portions comprise arrays of the two cells shown in FIG. 17 (or vice versa). The code can convey, for example, encoded payload data enabling a consumer's smartphone to link to a promotional web site or contest run by the company.

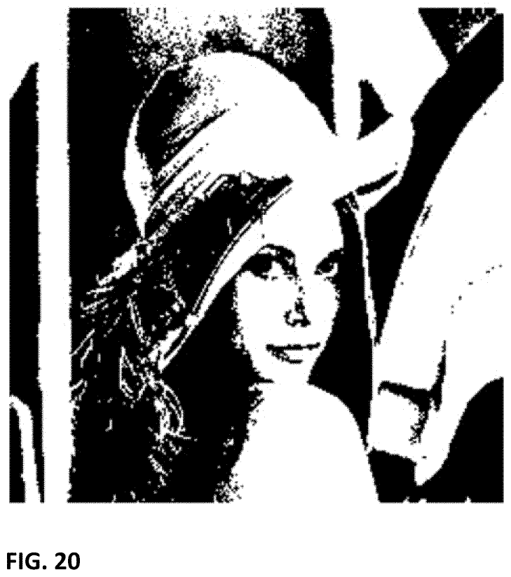

Greyscale and color imagery can be rendered in bitonal forms. One technique applies a simple thresholding operation. Pixels with values below a certain value are rendered as black; other pixels are rendered as white. FIG. 20 shows a photographic greyscale image rendered as bitonal in such thresholding fashion.

Like the text and logo just-discussed, this photographic image can be rendered using the four cells of FIGS. 17 and 18. The photograph region is virtually divided into cell-sized areas (e.g., 169 microns on a side). Each cell has one of two states, collectively conveying the binary 2D code. Where the thresholded image is black, cells having the FIG. 17 patterns 171 and 172 are used for the two states. Where the thresholded image is white, cells having the FIG. 18 patterns 181 and 182 are used for the two states. Where a black/white boundary crosses a cell, the cell may be similarly split, with part using a pattern from FIG. 17, and part using a pattern from FIG. 18.

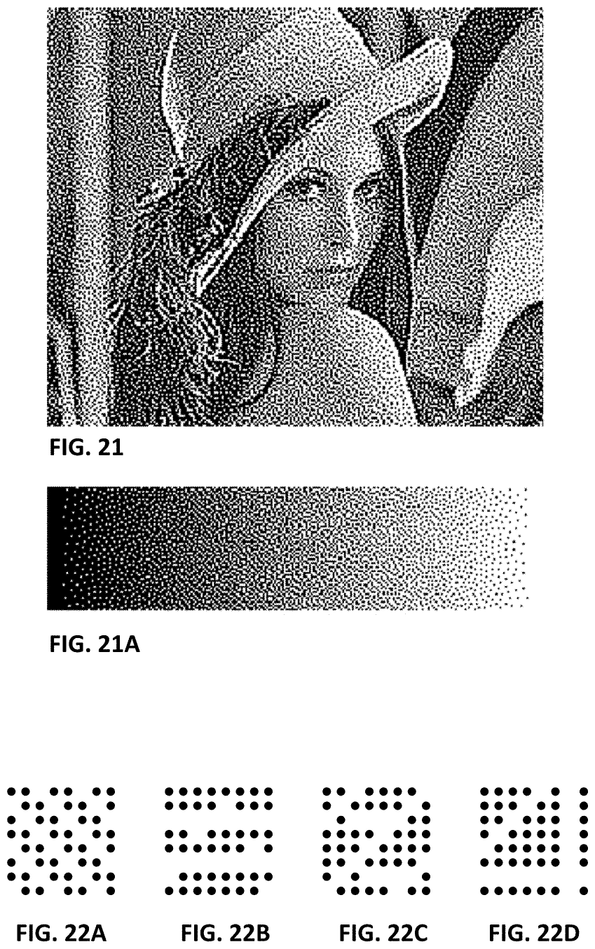

While thresholding is one technique for converting a multi-tone image to two tones, other techniques can be used to achieve better visual aesthetics. One such alternative is the direct binary search (DBS) method for image halftoning (Analoui and Allebach, Model-Based Halftoning Using Direct Binary Search, Human Vision, Visual Processing, and Digital Display III 1992 Aug. 27, Vol. 1666, pp. 96-108, International Society for Optics and Photonics). In such arrangement (FIGS. 21 and 21A), different greyscale tones are mapped to different bitonal spatial patterns, shown in FIG. 21A. By use of such patterns, renderings like that of FIG. 21 can be achieved.

The present technology can be applied here as before. A tiled array of virtual cells is defined, co-extensive with the area to be marked. Some convey a “1” symbol of the 2D binary code; some convey a “0” symbol. (Repeats of the code can be tiled edge-to-edge as needed to span the area.) If a cell is to convey a “0” symbol, and corresponds to a white area in the FIG. 20 rendering, cell pattern 181 is used; if it corresponds to a black area in the FIG. 20 rendering, cell pattern 171 is used. Similarly, if the cell is to convey a “1” symbol, and corresponds to a white area in the FIG. 20 rendering, cell pattern 182 is used; if it corresponds to a black area in the FIG. 20 rendering, cell pattern 172 is used. (Or vice versa; here, as elsewhere, the assignment of symbol values to cell types is arbitrary.)

Thus, a further aspect of the present technology is a method that includes forming a physical counterpart to a bitonal graphic, where the graphic has first and second areas of first and second tones, respectively. This forming includes the first tone using cells having first and second different patterns, and representing the second tone using cells having third and fourth different patterns. A resultant array of cells is then formed on a surface (e.g., by laser marking), where the cells define elements of a 2D code.

Such arrangement is not limited to bitonal renderings. A still further aspect of the present technology concerns representing non-binary images and other graphics by marking metal molds to convey coded binary data.

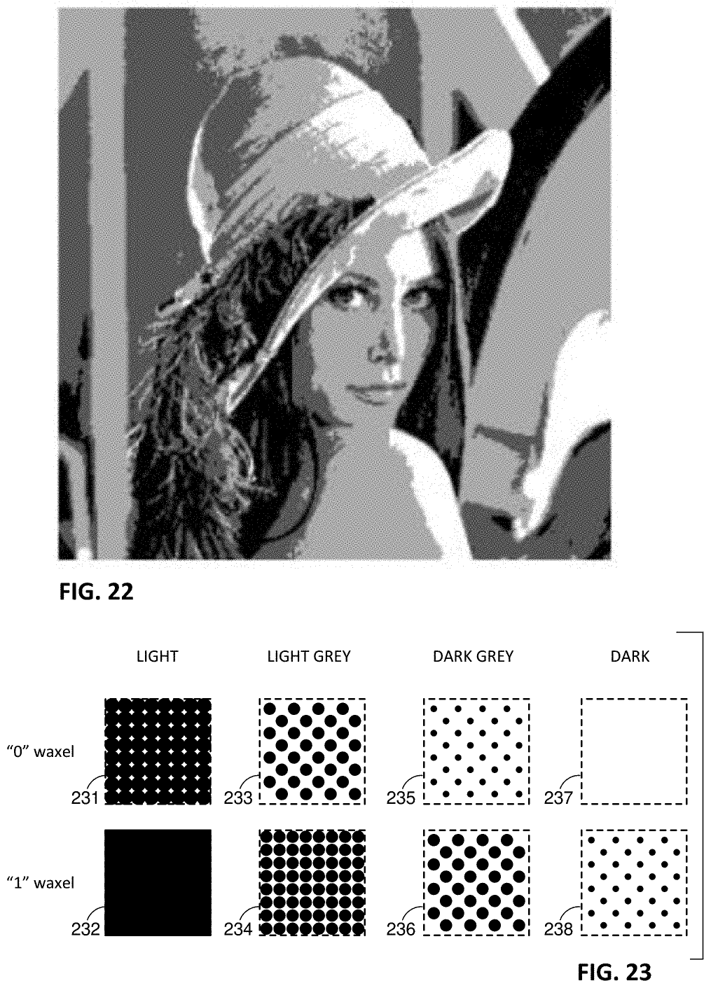

Consider FIG. 22, which shows a greyscale image converted (by simple thresholding) to a 4-tone image. The four tones may be termed (a) light; (b) light grey; (c) dark grey; and (d) dark. For each tone there are two cell patterns. As before, the image area is virtually-divided into cells, which are assigned “0” or “1” symbols in accordance with the coding method. In areas where thresholding yields the light tone, each cell is assigned the pattern 231 or 232, depending on whether the cell is to represent the “0” or “1” symbol, respectively. (Recall that cell 232 is wholly textured, making it the lightest of the cells. In contrast, cell 237 is unmarked and is specularly-reflective, making it usually the darkest-appearing of the cells.) The other tones of the artwork are similarly each assigned a pair of the patterns, to indicate the two message code states.

In the examples just-given, cells within a given area of a 2- or 4-tone graphic are selected from one of two patterns, depending on whether the cells represent “0” or “1” symbols. However, the choice needn't be just from two patterns. A multitude of patterns can usually be fashioned, each with the same or nearly the same (e.g., +/−5%) macro visual appearance, e.g., diffusely scattering the same amount of light. FIGS. 22A-22D, for example, show four patterns with nearly the same aggregate areas marked. Such patterns can be used interchangeably. In like fashion, for all but the fully textured and fully smooth patterns of FIG. 23 there are a large number of alternative patterns with similar aggregate area marked that may be substituted.

A still further aspect of the technology is a method that includes forming a physical counterpart to a non-bitonal graphic, such as the image of FIG. 22. Such graphic can have three or more areas, each of a different tone. This is done by representing a first tone using cells having both first and second patterns (e.g., patterns 231 and 232); representing a second tone using cells having both third and fourth patterns (e.g., patterns 233 and 234); and representing a third tone using cells having both fifth and sixth patterns (e.g., patterns 237 and 238). The resulting array of cells is formed on a surface, e.g., by laser marking. These cells define elements of a 2D code.

Yet another aspect of the technology is a method that includes forming a physical counterpart to a continuous tone watermark code. This code includes four or more areas, each associated with a different value. This is done by rendering the first area by laser-marking a surface with a first pattern; rendering the second area by laser-marking the surface with a second pattern; rendering the third area by laser-marking the surface with a third pattern; and rendering the fourth area by laser-marking the surface with a fourth pattern; wherein each of these patterns is different.

While the foregoing discussion considered representations of binary codes on metal surfaces of plastic injection molds, aspects of the technology can also be used to represent non-binary code signals on such surfaces.

Some 2D codes are non-binary. Watermarks, for example, can be represented in so-called “continuous tone” fashion, employing a multitude of different or signal values. (Such watermarks are not really continuous, due to the constraints of digital quantization. But typically dozens—if not hundreds—of different values are included in a typical “continuous tone” watermark signal.)

As is familiar from the documents identified below, watermark generation commonly combines a 2D greyscale (or floating point) reference signal with a 2D payload signal in a weighted sum. The reference signal, which enables geometric synchronization of the payload signal, is typically dominant.

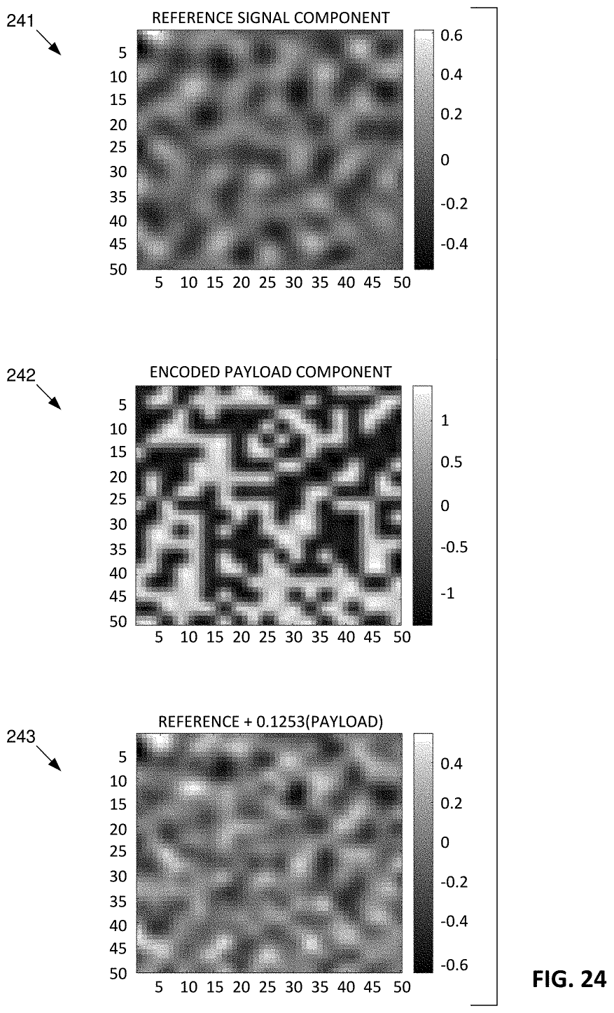

FIG. 24 illustrates. A 2D reference signal 241 (e.g., the sum of dozens of 2D sinusoids) is summed with a weighted version of a payload signal 242 (here interpolated from a lower resolution counterpart, which transforms binary symbols into greyscale or floating point data) to yield a final “continuous tone” watermark pattern 243. (FIG. 24 depicts just a 50×50 pixel excerpt of a watermark block in order to reveal detail. A full watermark block is more typically 64, 96, 128 or 256 pixels on a side.) A binary watermark pattern (sometimes termed a “sparse” watermark pattern) can be derived from a continuous tone watermark pattern by various methods, as detailed in the below-cited documents (e.g., U.S. 20190332840). But in doing so some of the signal energy is lost. Where signal energy is critical, a continuous tone watermark can be advantageous.

In a particular embodiment, cell values within a non-binary code signal are each mapped to a corresponding cell design (e.g., a particular arrangement of multiple texture features). For example, the value of the lightest extrema in the pattern 243 may be mapped to a textured pattern that effects a maximal reflectance of incident light towards a camera (e.g., large surface roughness). Progressively darker extrema may be mapped to patterns that effect progressively less reflectance of light (e.g., smaller surface roughness), until the darkest extrema are mapped to the unmarked specular metal surface. (Again, the specular reflection of an unmarked metal surface commonly looks dark to a camera, unless the illumination is positioned so its reflection is directed to the camera.)

This mapping may be performed on a per-waxel basis, so each block of watermark pattern is rendered as a, e.g., 128×128 cell array of metal textures. Or it may be performed based on averages of small local groupings of waxels, e.g., 2×2.

Due to the large number of different values (tones) in the continuous tone watermark pattern 243, a simplification can be effected by quantization. That is, the watermark signal values can be quantized into a smaller number of ranges, e.g., 8 or 16. The lightest cell values (e.g., between 0.45 and 0.5 in the code 243 of FIG. 24) define one range, and are associated with a brightest (e.g., maximally-diffusing) texture pattern. A second range of values (e.g., between 0.4 and 0.45 in this example) are associated with a next-maximally-bright pattern. Successive ranges comprise successively lower values of the watermark signal, and are associated with successively less-bright patterns. Finally, the final (e.g., the 16th) range of watermark values is associated with the smooth metal pattern.

The just-described arrangement marks the metal with a pure watermark signal. In a variant arrangement the watermark signal is combined, in a weighted sum, with a host image (e.g., an 8-bit version of Lena). The weighting can locally adapt to different data hiding attributes of the host image as perceived by the human visual system, as is known from the below-noted references. The composite image, bearing the watermark, can then be converted into different regions of different texture patterns, to achieve varying degrees of brightness reflected or diffused from the metal surface and render a camera-perceptible version of the watermarked image.

Surface roughness is one parameter on which diffusion depends. Rougher surfaces generally scatter more light. (At extremes, however, deep cavities appear in the surface, which cause shadows, which counteracts the desired diffusion of light.) But roughness is not the only operative variable. There is also spatial frequency. If surface features are analogized to rough mountains and valleys, then the greater their number, the more light will be diffused. In contrast, a single mountain in an area, surrounded by flat plain, will have less diffusion and more reflection. Size of the features is another variable on which the amount of light diffusion depends.

Thus, in establishing different texture patterns with different degrees of light diffusion for the above-detailed arrangements, progressively-decreasing signal values do not always correspond to progressively-decreasing roughness (or progressively-decreasing spatial frequency, or feature size). In some instances, less light diffusion may be achieved by increasing the surface roughness, but diminishing the spatial frequency. Etc.

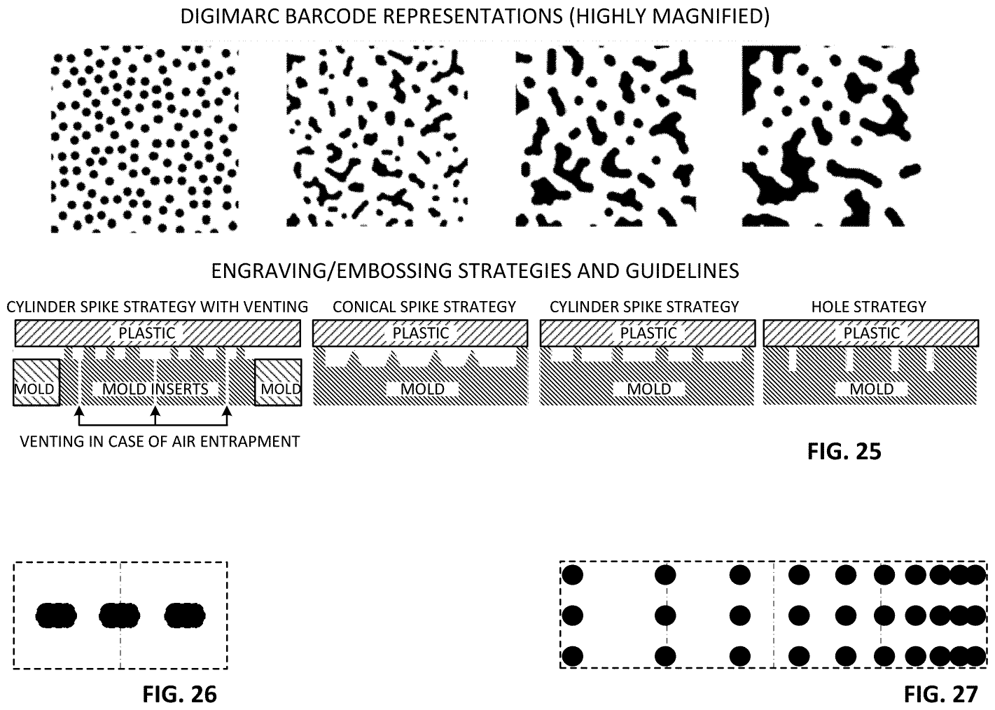

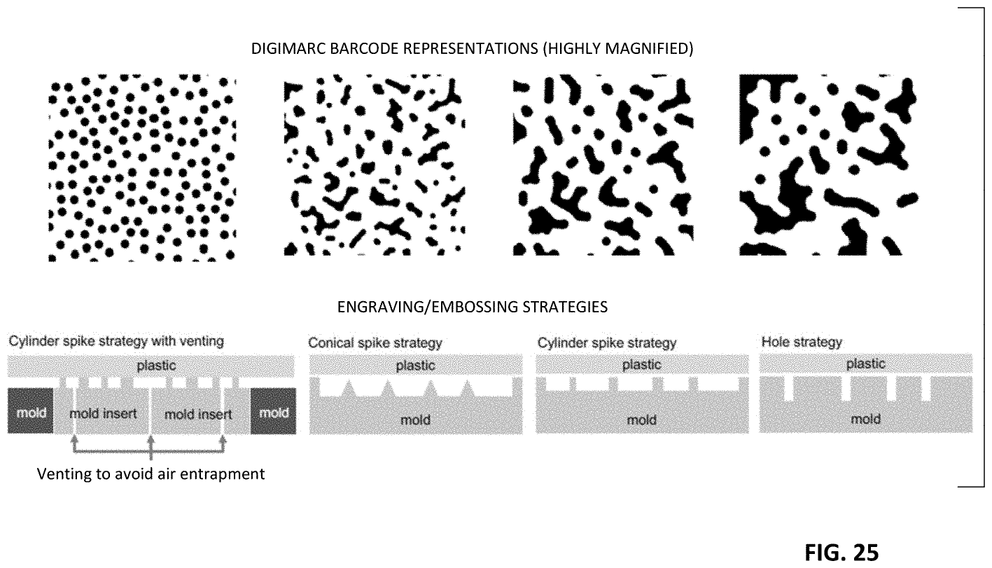

FIG. 25 shows, at the bottom, certain mold configurations that are taught in applicant's previous patent filings concerning thermoforming and, at the top, certain patterns that can be formed. Such mold configurations and patterns can likewise be applied in the context of injection molding.

### Catalogs of Textures; Style Transfer

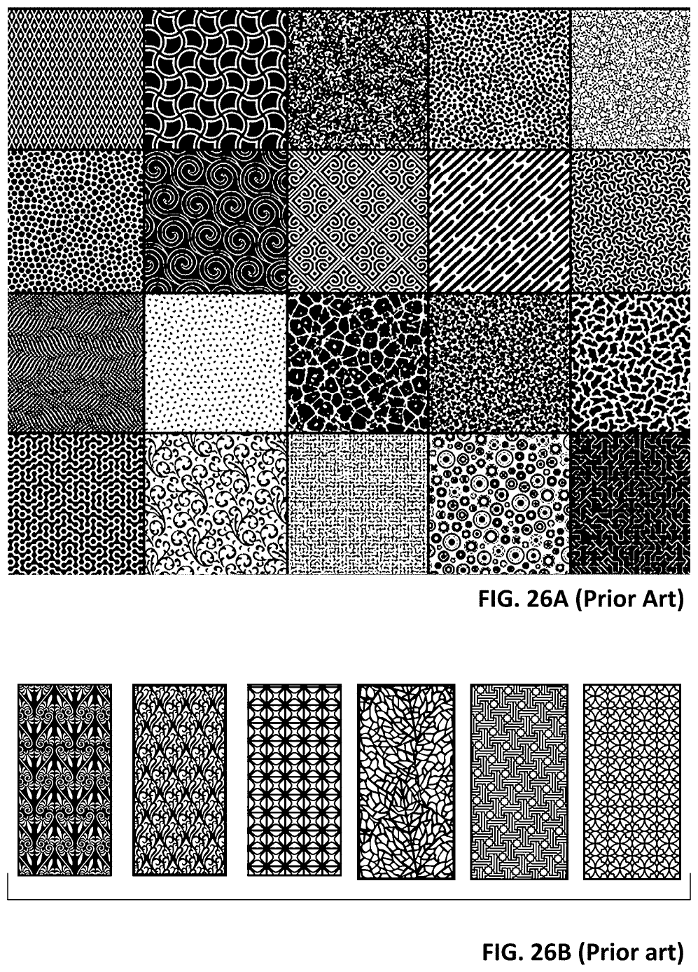

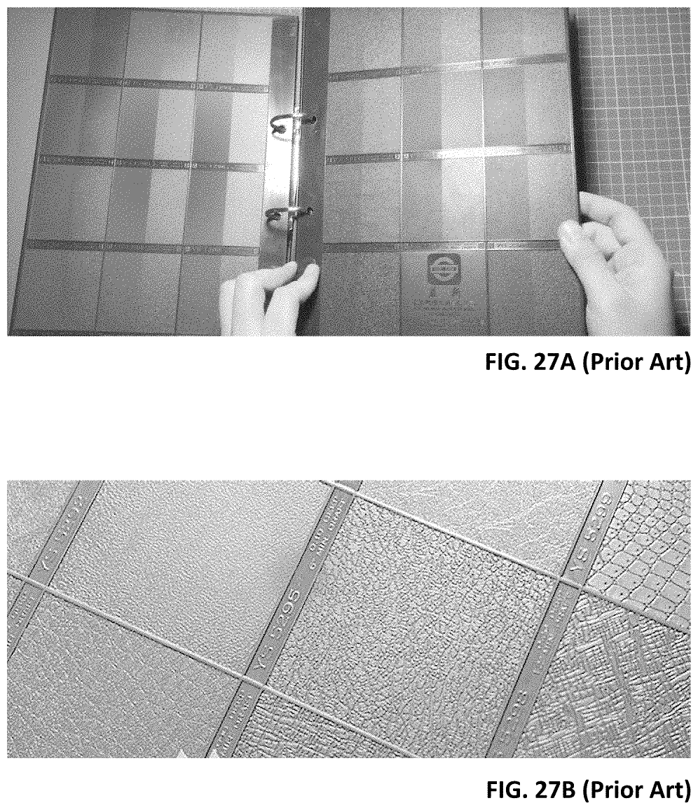

Laser engraving companies sometimes make available catalogs of stock texture patterns that can be engraved into substrates. A small assortment of representative patterns is shown (in 2D form) in FIGS. 26A and 26B. Samples are sometimes provided on plastic plates, bound in a 3-ring binder, as shown in FIGS. 27A and 27B. (These figures show a catalog produced by Yick Sang Metal and Plastic Mould Texturing Ltd.) The Society of German Engineers (Verein Deutscher Ingenieure) has similarly defined a set of standardized stock textures (VDI 3400), from which injection molders can select for texturing their molds.

Such patterns can be transformed to convey digital watermark payloads, while still maintaining aesthetically-pleasing appearances. (Here, as in many cases, aesthetically-pleasing appearance is provided by features such as use of repetition of a single shape (or a single class of shape—such as lines or bumps or other elements having a common orientation, curvature, or attribute) many times through a pattern—at the same scale or at different scales, or symmetry of the pattern or a component element. (The opposite of aesthetically-pleasing might be termed chaotic—lacking any rational structure.)

One way to transform such a stock texture pattern, to convey a digital watermark payload, is by use of a style transfer neural network. The network acts to transform the watermark pattern to incorporate features of the style (stock texture) pattern. See, e.g., our U.S. patent publication 20190213705, and the landmark papers by Gatys, et al, A Neural Algorithm of Artistic Style, arXiv preprint arXiv:1508.06576, Aug. 26, 2015, and Johnson, et al, Perceptual Losses for Real-Time Style Transfer and Super-Resolution, European Conference on Computer Vision, Oct. 8, 2016, pp. 694-711. See also the survey papers by Jing et al, Neural Style Transfer: A Review, IEEE Transactions on Visualization and Computer Graphics, Jun. 6, 2019, 26(11), pp. 3365-85, and Singh, et al, Neural Style Transfer: A Critical Review, IEEE Access, Sep. 15, 2021. (The Johnson and Jing se papers are attached to U.S. priority application 63/265,146 as appendices. The Gatys paper is attached to U.S. application 62/596,730 as an appendix.)

A variety of implementations of Gatys' method have been published on Github. An example is found in the code repository of Crowson at github<dot>com/crowsonkb/style-transfer-pytorch. (The <dot> convention is used in lieu of a period, to assure there is no browser-executable code in this specification.)

A great variety of implementations of Johnson's method have also been published on Github, including Johnson's original implementation. See github<dot>com/jcjohnson/fast-neural-style. See, also, the code provided by Logan Engstrom, available at github<dot>com/1engstrom/fast-style-transfer. Still another implementation is code written by Adrian Rosebrock, using functionality of the open source library OpenCV (e.g., version 3.4.1), detailed at www<dot>pyimagesearch<dot>com/2018/08/27/neural-style-transfer-with-opencv/.

The Web Archive (web<dot>archive<dot>org) has backups of all these Github materials.

(Although the Gatys and Johnson methods are particularly identified, other style transfer technologies are known and can alternatively be employed.)

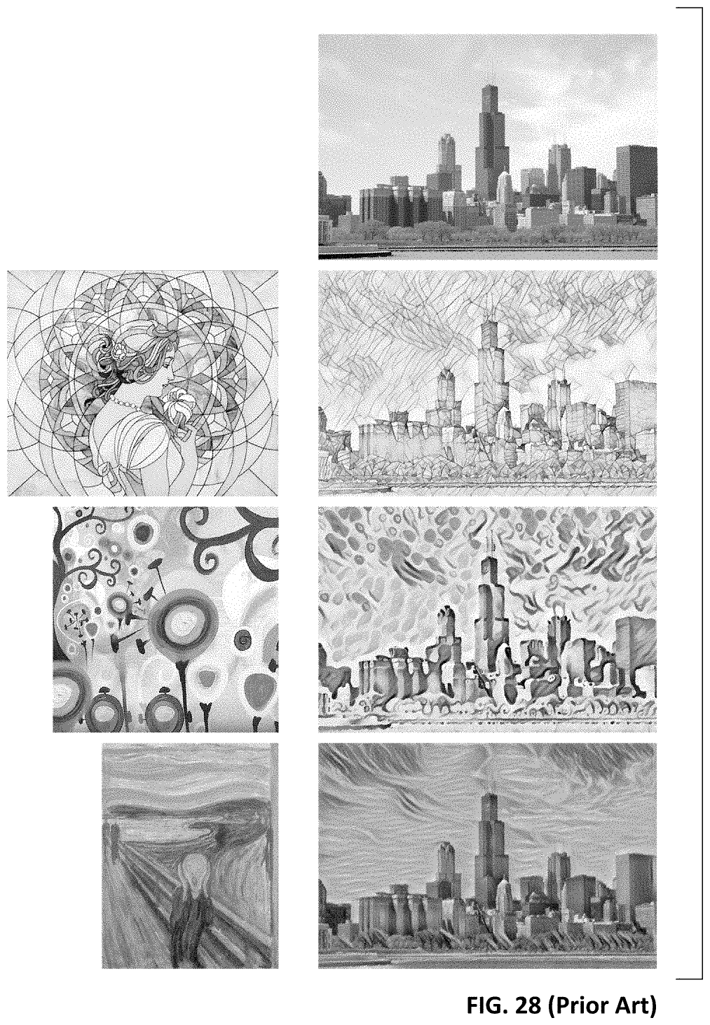

The concept of style transfer is illustrated by FIG. 28. This figure shows, in the upper right, a photo of Chicago. Along the left side are three works of reference artwork, from which style can be extracted by a neural network. Thereafter, each such neural network can apply the style to an input graphic, yielding a corresponding output graphic that incorporates style of the reference style artwork.

The right side of FIG. 28 shows output images produced by three networks trained in accordance with these three reference artworks, when the photo of Chicago is provided as the input image. (These examples are taken from the github site of Johnson that elaborates his above-cited paper. See github<dot>com/jcjohnson/fast-neural-style.) As can be seen, the style transfer network transforms the input photo to express its information content (its “semantic content,” e.g., the presence of buildings in a skyline, clouds, etc.) with the style of the reference style artwork, e.g., incorporating elements or brushstrokes or shading patterns or tone palettes derived from the reference artwork. Yet the gross structure of the input graphic (e.g., component elements and their positions, such the buildings and their placements in the photo of Chicago) is relatively unchanged.

The operation of the trained style transfer neural network is governed, in part, by one or more weighting parameters that establish(es) the relative weighting given to (a) the style of the reference artwork, and (b) the semantic content of the input graphic, in producing the stylized output. This weighting determines whether the output is to be highly stylized (and thereby substantially changed from the input), or only slightly stylized (and thereby substantially unchanged from the input), or somewhere in-between. This parameter is set by the implementer based on needs of the particular application.

In aspects of the present technology, the input graphic is a 2D code signal such as a digital watermark pattern, and the need is for the payload of the code to be reliably decodable from the stylized output image.

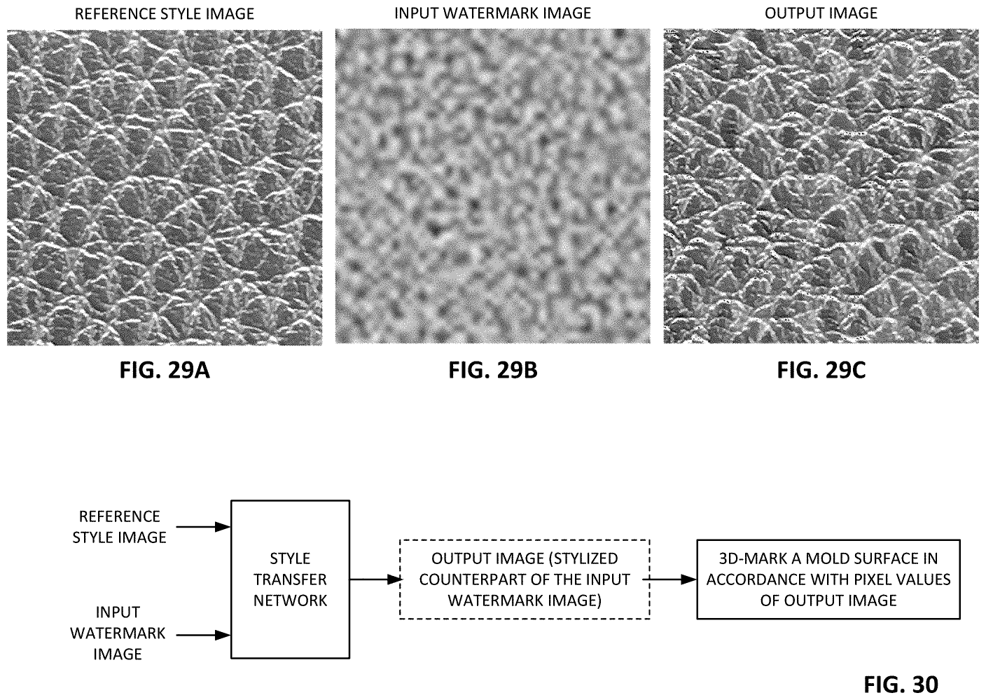

A particular example is illustrated by FIGS. 29A-29C. Here the style image (FIG. 29A) is a leather-like texture pattern, such as a stock leather texture pattern available from a catalog, as described earlier. The content image that is to be stylized is a continuous-tone watermark image shown in FIG. 29B (instead of a photo of Chicago). The output produced by the style transfer network is shown in FIG. 29C. The style transfer network used in this example is based on code from the above-noted Crowson Github repository.

As is familiar to artisans, a continuous-tone watermark pattern encodes, by its spatially-varying pattern of relatively-darker and -lighter regions, a plural-bit watermark payload signal, and an associated calibration (reference) signal that permits a compliant decoder to identify and sync to the payload signal. In other embodiments, forms of watermark signals other than continuous-tone watermark patterns can be used, e.g., binary patterns—such as a pattern of black dots on a white background.

To the human observer, the similarity of the FIG. 29C output image is strongest to the reference style image (FIG. 29A). That is, the output image looks like a leather pattern. However, a compliant watermark decoder will find, in its analysis, that the stylized output pattern maintains semantic content from the input watermark image (FIG. 29B), i.e., the spatially-varying pattern of relatively-darker and -lighter areas that serves to encode the payload and calibration watermark signals. These minute spatial variations are visually lost to the human observer due the visual busyness of the leather pattern.

The balance of expression between the reference leather style image of FIG. 29A, and the semantic content of the FIG. 29B watermark image, within the output image of FIG. 29C, is set by the earlier-referenced weighting parameter(s). The more the style is weighed, the less robustly the watermark signal is expressed. The more the content is weighted, the more robustly the watermark signal is expressed.

In one implementation, this weighting is initially set to highly-stylize the output—favoring the reference style over the watermark semantic content. This weighting is then iteratively reduced (reducing the applied stylization) until expression of the watermark pattern (the semantic content) in the stylized output rises to a desired degree of strength (robustness).

(Robustness of a watermark-conveying pattern can be assessed by adding increasing levels of Gaussian noise to the output pattern to determine the noise level at which correct payload decoding from the output pattern by a watermark decoder falls below 50%. The larger this noise level at which the payload can still be correctly decoded 50% of the time, the more robust is the watermark in the pattern. Such assessments can be performed over dozens or hundreds of trials, and averaged, to yield a reliable metric. See, e.g., U.S. Pat. No. 10,217,182. Watermark strength metrics are also detailed in U.S. Pat. Nos. 7,286,685 and 10,506,128.)

In another implementation, an inverse procedure is used. That is, the weighting is initially set to favor the watermark signal of FIG. 29B—with the style of FIG. 29A expressed only weakly. The weighting is then progressively changed to increase expression of the reference leather style in the output image until some measure of its adequate expression is met. (This measure is usually subjective, e.g., an operator's conclusion that the output pattern looks leather-like enough.) The output image is then checked to assure that, with such weighting, the image still expresses the watermark image semantic content with at least a desired degree of robustness.

Leather patterns are a species of a more general class of 3D textures that are suitable for neural network-based style transfer watermarking: patterns found in nature. Such patterns also include, e.g., patterns found in clouds, terrain (both macro and micro, e.g., landscapes and sand patterns), rocks and minerals, and plants and animals (and their respective cellular structures).

For leather and many other natural patterns, the ratio of Rz/Ra (as those parameters are defined earlier) is commonly 3-5, but not infrequently ranges up to 6 or 8, and less frequently ranges into the double-digits (and in some extreme cases up to 100 or more). The following Table 1 details Ra and Rz measurements taken from seven different bovine leathers (L1-L7), which are here characterized by ratios in the range of 4.2 to 15, with most in the range of 5-6:

TABLE 1

| Leather | Ra (microns) | Rz (microns) |
|---|---|---|
| L1 | 3.87-5.84 | 20.75-24.59 |
| L2 | 5.26-5.53 | 27.50-33.38 |
| L3 | 3.36-5.24 | 50.58-58.79 |
| L4 | 7.25-9.98 | 37.21-46.23 |
| L5 | 6.45-6.94 | 32.40-42.81 |
| L6 | 3.31-3.79 | 18.52-21.25 |
| L7 | 3.65-4.02 | 20.71-23.44 |

The following Table 2 details Ra and Rz measurements of a few of the many leather-like texture patterns available from the catalog of Yick Sang Metal and Plastic Mould Texturing Ltd.

TABLE 2

| | | |
|---|---|---|
| YS-20049 | 8.96 | 30.59 |
| YS-20050 | 8.09 | 32.44 |
| YS-20051 | 6.9 | 25.19 |
| YS-20052 | 5.74 | 21.56 |
| YS-20053 | 4.61 | 18.6 |
| YS-20054 | 6.98 | 25.17 |
| YS-20075 | 3.68 | 12.32 |

Substantially all of these Yick Sang plastic textures have Rz/Rz ratios between 3.3 and 4.

Such patterns are well-suited for use as reference style artwork because they include an element of randomness, disorder or irregularity, which serves to help obscure the presence of the watermark signal. FIGS. 15A-15ZZ of U.S. publication 20190213705 also show patterns having such attributes. Many are natural patterns. Some are not, such as basket weaves and coarse fabric weaves.

In contrast, an example of a regular pattern is a pattern that includes multiple common graphics spaced at uniform intervals. For instance, of the six patterns in FIG. 26B, all but the fourth are regular pattern blocks. Such patterns are relatively less-favored as style images for use with the present technology, although they can be used.

It will be understood that the greyscale values in the leather-styled watermark output pattern of FIG. 29C (and in other 2D illustrations herein) map to 3D profile levels. For example, a mold shaped with the FIG. 29C pattern is milled to a maximum depth where the greyscale value is darkest (i.e., closest to zero), and is milled to a minimum depth (or not at all), where the greyscale value is lightest (i.e., closest to 255 in an 8-bit greyscale system). The mold surface is milled to a middle depth (e.g., half of Rz) for a mid-greyscale value. Such shaping of the mold produces a correspondingly-inverted relief pattern on a plastic item produced by the mold: the dark areas are high in profile on the plastic surface, while the light areas are the deepest valleys.

The value of Rz can be set to achieve a degree of watermark robustness required by the intended application. The greater the value of Rz, the greater the watermark robustness. Rather than being in the range of tens of microns (as is commonly found in catalog textures), applicant has found that it is often preferable to set the value of Rz to the hundreds of microns. In some exemplary embodiments, Rz is between 100 and 300 microns. Ra is a fraction of this amount, per the above-noted ratios. (Again, Rz defines the depth of the mold surface at the darkest locations in the stylized artwork of FIG. 29C, with progressively less depths corresponding to progressively lighter locations.)

FIG. 30 is a flow chart of a mold-making process based on the foregoing.

Digital watermark pattern blocks are typically tiled, edge-to-edge, to span larger areas of surfaces. To avoid edge discontinuities at the tiling junctions, watermark pattern blocks are typically arranged to be cyclically continuous—from the left edge to the right edge, and from the top edge to the bottom edge. (Cyclical continuity is commonly achieved by selecting, for the dominant reference signal component of the watermark pattern block, an ensemble of spatial waveforms that are of integer frequencies, so each component waveform is continuous across tiling boundaries.)

The style transfer operation can introduce edge discontinuities at tiling boundaries, such that the stylized pattern may not be cyclically continuous at opposite edges. These edge discontinuities are expressed in the pattern milled in the mold, and are similarly expressed as conspicuous texture pattern boundary lines on plastic objects produced from the mold.

To overcome this problem, applicant has found it advantageous to assemble a collage of multiple digital watermark pattern blocks, tiled edge to edge, thereby providing a watermark content image that is larger than a single block. Within this larger image there are no edge discontinuities. This larger content image is then stylized using the style transfer network. The resulting larger stylized image has no edge discontinuities within its interior. A central portion of this resulting larger stylized image is then excerpted and used to establish the milling depth of the mold—avoiding the need for the tiling of multiple stylized blocks. By avoiding tiling of small stylized image blocks, edge discontinuities are avoided, and the molded plastic object is free of conspicuous pattern boundary lines.

Additionally, or alternatively, the style transfer network operation can be configured to heed boundary edge continuity as a factor in producing the stylized output image.

Reference was earlier made to the weighting applied by the style transfer network between style and content. Such weighting is commonly expressed by a style loss function and a content loss function. These two functions are weighted by corresponding weighting factors, and the results are summed to yield a total loss function. Training of the style transfer network involves changing parameter weights and coefficients to minimize this total loss function, e.g., using a backpropagation process, such as reverse gradient descent.

Applicant has found that the style transfer network can also operate to minimize cyclical edge discontinuities by adding a third factor into the total loss function: one that expresses a degree of edge discontinuity in the stylized block.

In one implementation, this third factor is a mean squared error metric, computed using values of corresponding pixels along the top and bottom edges, and also along the left and right edges, of the stylized block. That is, a difference is computed between the value of the left-most pixel on the top pixel row, and the left-most pixel on the bottom pixel row, and this difference value is squared. A squared difference is then similarly computed between the two pixels next-to-the-right along the top and bottom edges. And so forth along the length of the top and bottom edges. Likewise, a difference is computed between the top-most pixel on the left edge of the block, and the top-most pixel on the right edge of the block, and this value is squared. Such operation is repeated for other pairs of corresponding pixels down the left and right edges of the block. These squared values are then all summed. This sum yields a number indicative of the degree of cyclical edge discontinuity along the four sides of the stylized block.

In a variant implementation, the metric is not based on corresponding pairs of individual pixels along the stylized block edges, but rather between averages of multiple pixels. For example, a difference is computed between (a) an average of the top five pixels in the left-most column of block pixels, and (b) an average of the bottom five pixels in the left-most column of block pixels. And so forth across the top and bottom edges. And likewise across the left and right edges. (The averaging of five pixel vales is exemplary only. Other values—larger and smaller—can be used. Typically, larger values are used with larger image sizes.)

As with the style loss and content loss weights, the edge continuity loss is assigned a weight in computing the total loss function. This latter weight determines whether edge continuity is given more or less precedence in creating the final stylized output image. (Typically, a higher weight given to edge continuity means that style and content are given less precedence in creating the final stylized output image, so an operator again needs to make a balancing judgment, which again will depend on the requirements of the particular application.)

Just as organizations presently provide catalogs containing physical samples of texture patterns, applicant envisions that such catalogs can likewise be provided to show physical samples of watermark-containing textures. Such samples demonstrate, to customers, that they can convey payload data in texturing of their products without sacrificing the aesthetics of traditional texture patterns. Each such sample would be tested to confirm it provides a threshold degree of watermark robustness—assuring customers that the textures in the catalog are ready for application to products.

A different way to transform an input texture pattern, such as the leather-like pattern represented by FIG. 29A, into a watermark-conveying pattern, is to make a random perturbation of the texture, and compare correlation of the result with the watermark pattern before and after the perturbation. If the perturbation decreases the correlation, un-do such change and apply a different perturbation. If the perturbation increases the correlation, maintain such change and apply a further random perturbation. Continue this process until the robustness of the watermark signal expressed by the multiply-perturbed stock pattern meets a desired threshold.

The perturbation that is applied to the laser engraving stock pattern can be of different forms. One is by adding or subtracting, e.g., adding a dot in a white area, or removing a dot from a marked area. In the case of vector pattern artwork (which is the usual case with laser engraving patterns), the perturbation can take the form of shifting the position or the width of the line, e.g., by ten, or dozens, or hundreds of microns. If the stock pattern is a greyscale pattern (as opposed to the bitonal patterns of FIGS. 26A and 26B), the perturbation can comprise changing the greyscale value of an element or region, e.g., by ten digital numbers in a 0-255 representation.

In a further embodiment, a Markov chain approach is employed, which is seeded by a starting texture tile. An area adjacent this tile is created based on a Markov model of the starting tile, predicting a continuation of the tile pattern beyond its boundary based on vertical and horizontal pixel-transition probabilities within the starting tile, expressed as a Markov transition matrix. Multiple predictions are made for the adjoining area, and each is tested to determine which is most highly-correlated with the desired watermark pattern. Whichever best-correlates with the watermark pattern is adopted. The method continues in this fashion, growing from the starting texture tile, filling-in adjacent areas with areas of graphics whose transition statistics are modeled after those of the starting tile.

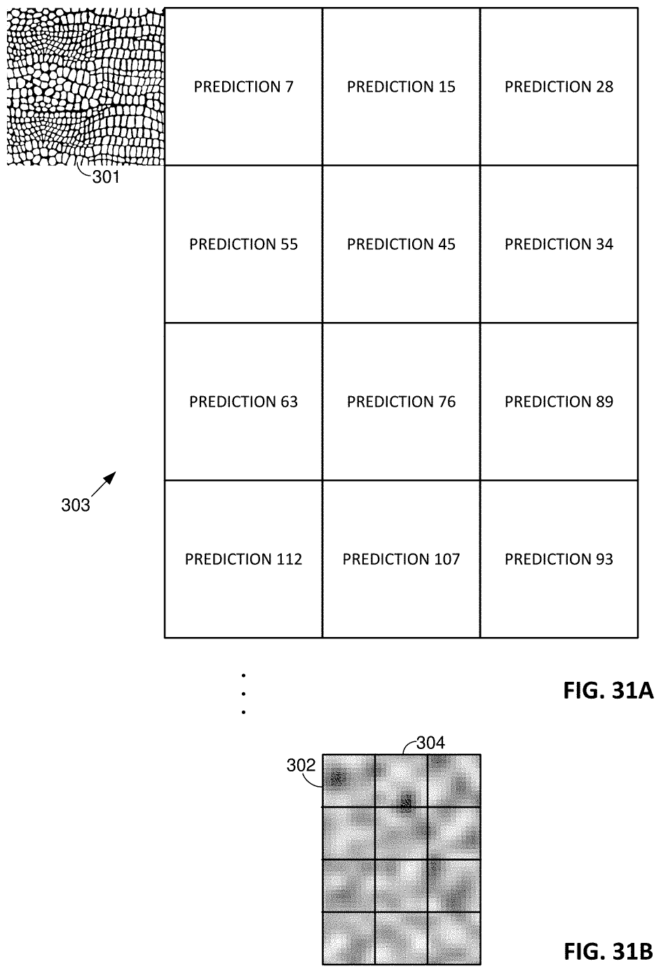

FIGS. 31A and 31B illustrate. The starting texture tile 301 is shown at the upper left. As discussed earlier, this tile desirably has a degree of randomness. Ten predictions are made based on this tile, and each is checked for correlation with an excerpt 302 of the continuous tone watermark pattern shown in FIG. 31B. Prediction 7 is selected as best-mimicking this except, so it is included as the first excerpt in a pattern area 303 being generated.

The process continues for a next excerpt 304 in the watermark pattern. Ten more predictions are made. Prediction 15 is found to define a pattern tile that best mimics (i.e., best-correlates with) watermark excerpt 304. Prediction 15 is thus included as the second tile in the growing pattern area 303.

The method continues in this fashion—each time predicting multiple possible tiles, and selecting one (Prediction 28, Prediction 34, Prediction 45, etc., in this example) that best-mimics a corresponding excerpt of the watermark pattern. By this arrangement, a composite pattern 303 grows, formed of blocks that have light/dark contrast features which spatially correlate with associated excerpts of the watermark pattern

(The regions of the watermark pattern that are being mimicked can be individual watermark cells within a 128×128 block of cells, but more commonly are arrays of several cells, such as 4×4 or 16×16 cell regions. The watermark cells can be bitonal, e.g., black/white, or they may be continuous-tone—as in this example.) After a predicted block corresponding to each excerpt of the watermark pattern is identified, the pattern is finished. The starting block 301 (which was chosen irrespective of any watermark excerpt) is deleted from the resultant graphic.

(More than ten predictions can naturally be made for each block location; the more predictions, the greater the correlation between the composite pattern and the target digital watermark pattern.)

In a variant embodiment, the just-described Markov or perturbation methods are used to generate a pattern that is correlated with the watermark reference signal component, e.g., as shown at the top of FIG. 24. This component typically dominates the composite watermark pattern (e.g., as indicated at the bottom of FIG. 24). The encoded payload component of the watermark can then be added to the pattern otherwise, such as by the addition of dark dots or light voids within the just-mentioned pattern. The aesthetically-pleasing pattern is still present, but does not need to be recomputed for each different watermark payload.

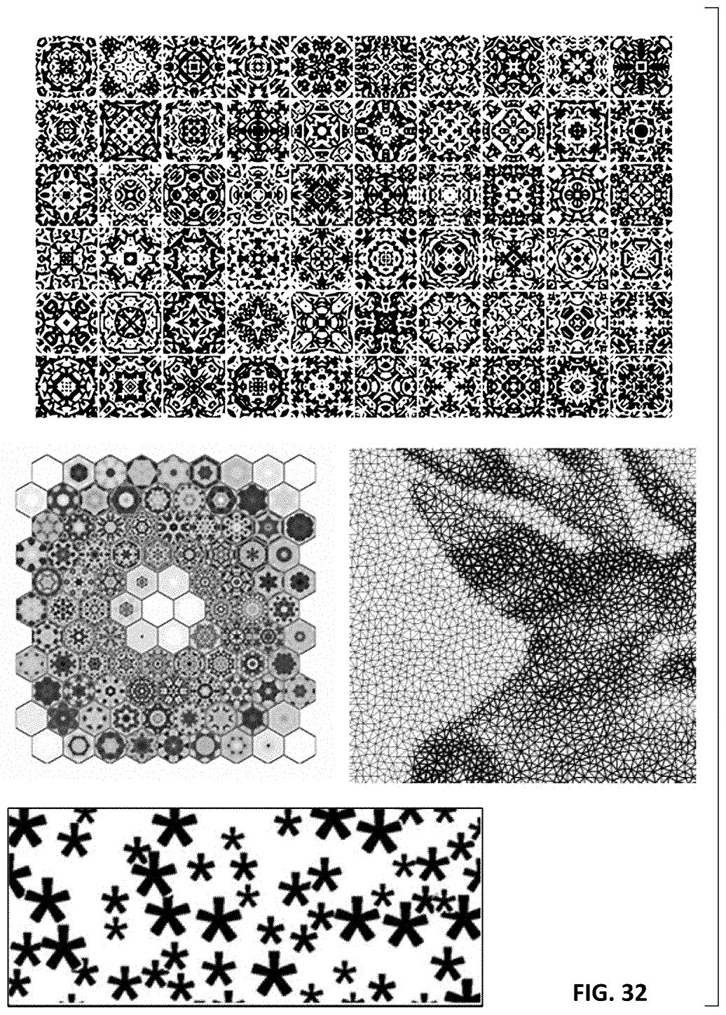

In still other embodiments, aesthetically-pleasing patterns conveying digital watermarks can be produced using “signal rich art” methods detailed in U.S. patent publications 20190378235 and 20200311505, and in pending U.S. application Ser. No. 17/516,464, filed Nov. 1, 2021. FIG. 32 is a collection of illustrations from these documents, exemplifying the variety of watermark signal-bearing artwork with which molds can be shaped.

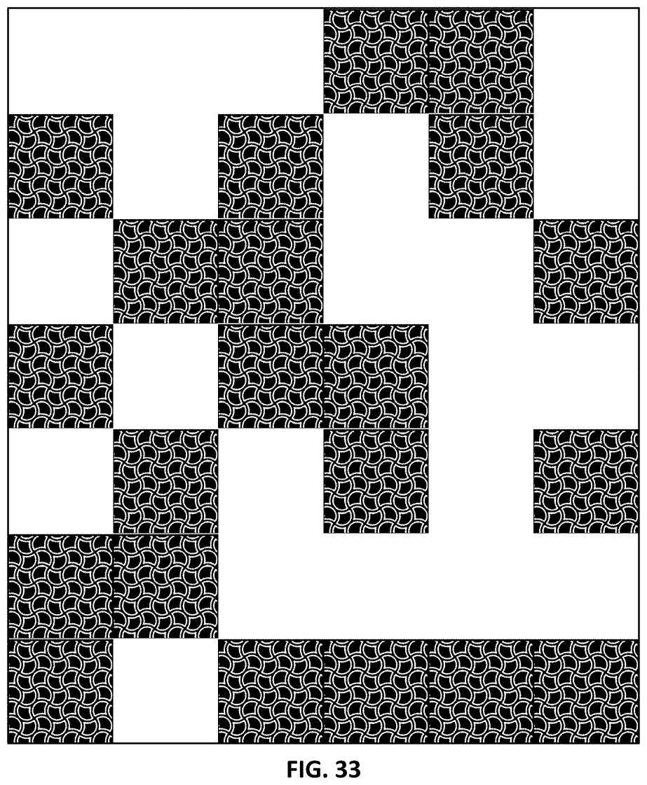

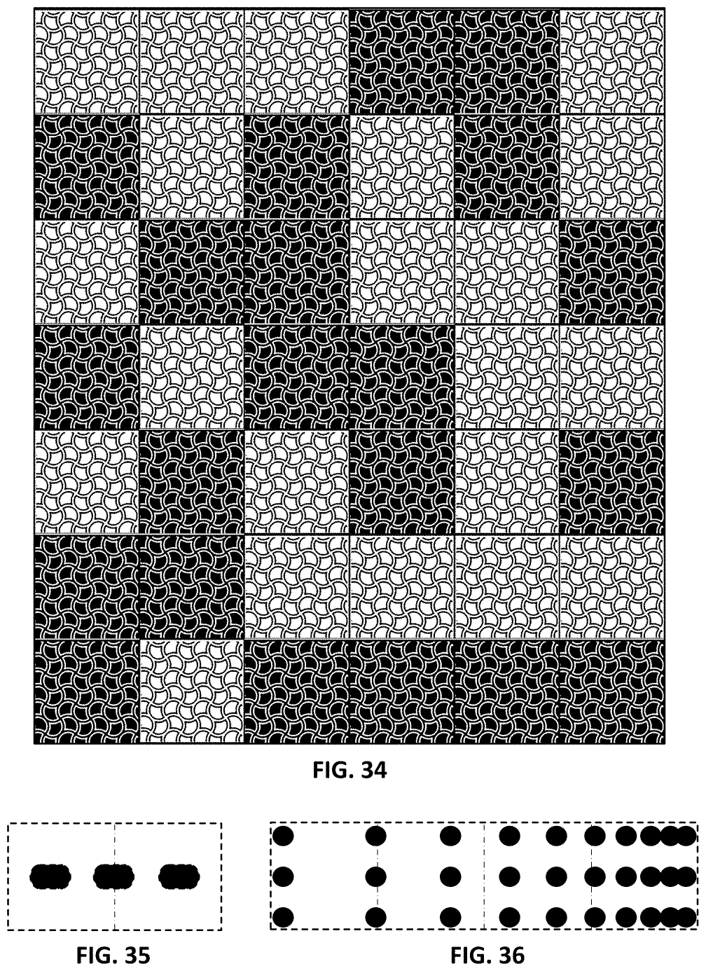

In some embodiments of the present technology, aesthetically-pleasing patterns—or excerpts from such patterns—are used as marks to define a 2D code, instead of the dots or other markings described elsewhere. FIG. 33 illustrates such an embodiment, in which one of the stock laser engraving patterns from FIG. 26A is used to mark cells of a 2D code. FIG. 34 shows a variant, in which two stock patterns are employed—one to for texturing “marked” cells and one for texturing “unmarked” cells. In this case, edge continuity is disregarded. In still other variants, there are transition zones between the centers of marked and unmarked cells, avoiding the hard edges (edge discontinuities) in FIG. 34.

### Concluding Remarks

Having described and illustrated aspects of the technology with reference to various embodiments, it should be understood that the technology is not so limited.

For example, while reference was made to 2D codes comprising regular, rectangular (square) arrays of cells, this is not necessary. Other arrangements can alternatively be used (e.g., hexagonal).

While the specification references steel molds, the technology is applicable with all manner of materials, including other metals (e.g., aluminum and titanium), ceramics and composites. Examples of suitable steels include 420FM, D2 tool steel, and 304 stainless. The compositions of such alloys are familiar to artisans. For example, 420RM includes 0.28-0.38% carbon, ≤1% silicon, ≤1.4% manganese, ≤0.03% phosphorous, 0.5-1% sulphur, 15-17% chromium, ≤1% nickel. Popular aluminum and titanium alloys include 6061 aluminum and titanium 6Al-4V (5% aluminum and 4% vanadium).

The emphasis of the specification has been on watermark code signals. However, the technology is likewise appliable with other forms of codes, such as QR codes and Data Matrix codes, and the “sparse path” codes detailed in our U.S. application 63/240,821, filed Sep. 3, 2021, and in published application WO2021/078842 to Filimade Holding BV.

The drawings illustrate a small number of cell patterns incorporating multiple features, by which different appearances can be achieved. But it will be recognized that the variety of such patterns is essentially endless.

The use of multiple micro-scale features to effect a particular macro-scale appearance (e.g., a degree of light diffusion or brightness) is known from the graphic arts, by techniques such as screening, halftoning and dithering. Screening, halftoning and dithering patterns known for print applications (e.g., for screen printing, offset printing and ink jet printing) can serve as patterns by which the surface of an injection mold can be shaped to yield macro effects with micro structures. For example, if a desired percentage area of cell is etched to form a light-diffusing texture pattern, it is straightforward to select screening parameters (e.g., number and size of features) to achieve such percentage. For example, if 20% of the area is to be made diffusive, the etched squares in a checkerboard pattern can be reduced to 40% of their normal size, so in the aggregate the etched squares no longer fill 50% of the cell area, but 40% of 50%, or 20%.

Similarly, imagery or a watermark pattern that has an intensity gradient can employ dithering to avoid banding that can occur when the rendering options provide coarsely-stepped intensities. An example is where an image, which may have 256 values in its original form, is rendered using 16 quantized levels (i.e., distinct cell patterns). Dithering noise can be added to obscure the boundaries between regions marked with different ones of the 16 levels.

Although the disclosure has addressed patterning of individual cells, mark patterns need not be defined on a per-cell basis. Instead, some patterns can be defined on a macro block-basis (e.g., 1×2 cells, 3×3 cells, etc.), to permit mark arrangements that would not be possible on a per-cell basis. Marks in some such arrangements can span inter-cell boundaries, e.g., as shown in FIG. 35. FIG. 36 shows a further example, in which mark spacings grow exponentially closer (raising their spatial frequency) towards the right in a 1×4 cell macro block.

While the detailed arrangements commonly form features within a cell using a textured matte finish (i.e., relatively roughened areas), other approaches can be used. One is to form hemispherical indentations—or protrusions—in the metal surface. A hemispherical indentation produces a corresponding hemispherical protrusion in the finished plastic part. Such shape has the optical property that incident light reflects towards all directions that have line-of-sight to the illuminated surface of the protrusion. Thus, each such feature typically reflects light to a camera system, forming a glint in the camera field of view. More particularly, some differential area on the rounded surface is oriented so that its surface normal bisects a line between the camera lens and the light source. This causes that differential area, if mirror-finished, to reflect all of its incident illumination from the light source into the camera. The surface, or course, is not mirror-finished, but the less rough the surface, the greater the fraction of light incident onto this area that is reflected into the camera.

Thus, in accordance with another aspect of the technology, a cell area on the metal surface is laser-shaped to include multiple generally hemispherical features. (The features can be protrusions or indentations; the effect is similar.) The greater the number of such features, the greater the aggregate light intensity reflected from a molded part to a camera having a view of the illuminated features. Similarly, the larger the size of each such feature, the larger is the differential area that contributes a glint of illumination back into the camera. Thus, two cells can be made to visibly contrast by fashioning each with a different number (or size) of generally hemispherical features. Returning, e.g., to FIG. 23, each of the features shown in cells 232-237 can be a generally hemispherical protrusion or depression. Cell 236 appears brighter to the camera than cell 235; cell 234 appears brighter to the camera than cell 233. Etc.

(For purposes of this specification, the term generally hemispherical is meant to include the fractional part of an oblate or prolate spheroid that extends above a plane through the spheroid, parallel to its equator. As a first approximation, all rounded 3D shapes have similar optical properties as regards scattering incident light—and generally include a differential area of surface oriented with its surface normal as described above.)

A related arrangement does not use hemispherical features but rather uses hemi-torus features—like a doughnut sliced in half by a plane perpendicular to the axis of the doughnut hole. Plural such half-donuts can be formed on a plastic molded part by reciprocal impressions etched into a mold surface. Such half-donuts on a molded part again have the advantageous property of reflecting light in a multitude of directions, due to the different 3D orientations of the differential areas of which the surface can be decomposed. As before, the number or size of such shapes formed in a given cell area define how bright the cell appears under illumination. As before, protrusions and indentations of such shape can be used.

In a further variant arrangement, a mold surface is laser-etched to leave features in the shape of cuboid corners. Items molded to incorporate such features include indented cuboid corners, whose surfaces act in concert to reflect light back in the direction from which it originated. If the light source and camera are angularly proximate (e.g., within 10 or 20 degrees of each other, as viewed from the item), then the greater the number of such features in a cell (or the greater their size), then the greater the illumination reflected back from the cell to the camera.

Although the description discusses various embodiments in which each cell is marked with plural features, marking a cell with a solitary feature is also possible, as noted earlier. The size of the solitary feature can be as small as the laser marking system permits, e.g., a dot 18 or 20 microns in diameter, which may be placed in the center (or elsewhere) within a cell that is larger (e.g., 169 microns on a side). At the other extreme, a solitary feature may be larger than the cell that it serves to mark—extending across some or all of its boundaries. Such feature may be a dot, or it may be another shape—such as a corporate logo, a silhouette, etc. See, e.g., U.S. patent publication 20210299706. When marking clear plastic, such as a water bottle, smaller marks are generally preferable, since the transparency of the material is not much impacted. Larger marks can make the plastic appear less-clear—sometimes cloudy. In these examples, as in the others detailed above, the depth of the markings has been found to be not particularly critical. For example, a mold depth of one micron or less (e.g., 0.5 microns) is sufficient for detection from camera imagery, and facilitates fast laser marking.

Applicant has found that reliable decoding can be achieved if the watermark signal is expressed with the tiny dots detailed herein (e.g., 20 microns), provided the imagery captured for decoding has a pixel resolution on the order of the distance between cell locations. That is, if the code is imaged at a resolution of 150 pixels per inch (i.e., each pixel spans an area of 169 microns on a side), then successive pixels in the sensor desirably map to successive locations that are spaced at least 169 microns apart on the object surface. (Experience actually indicates a spacing of 80% of the pixel pitch can be sufficient; that is the dot locations may be spaced 136 microns apart.) Such imagery is readily captured from a distance of 50 cm using computer vision camera systems like those detailed in cited publications WO2020186234 and U.S. 20210299706.

It will be recognized certain of the figures, if taken to be true to scale, depict marks that are smaller than the 18 micron figure stated earlier. This is to aid illustration. Moreover, the resolution of marking technologies keeps increasing, so applicant expects still-finer resolutions will be commercially available in the near future.

In one particular aspect, the technology comprises a plastic object—such as a beverage bottle—having a 2D code pattern (e.g., a digital watermark pattern or a 2D barcode pattern) molded thereon, where the 2D code pattern comprises an array of cell areas marked to define the pattern. Each cell area spans a width dimension “W,” such as 169 microns. The embodiment is characterized in that the marking includes one or more isolated marks within a cell area, where the one or more marks each has a maximum dimension “D” that is smaller than W/3. In some implementations, D is 50 microns or less.

(The 50 micron dimension, which is smaller than the width of most human hair (hair is commonly reported to have a diameter on the order of 75 microns), helps assure that the marking does not interfere with the object aesthetics. Yet, as noted, applicant's testing confirms that watermark patterns expressed using marks of this size are reliably readable.)

In variant implementations, the width dimension W is larger or smaller than 169 microns. In further variant implementations, the dimension D is 35 microns or less (or 25 microns or less, e.g., as shown in FIG. 3A).

A related aspect of the technology is a method of producing a mold to shape plastic objects of this description. Such method involves receiving data defining a 2D code pattern comprised of an array of cells, each cell having an associated state or value, and varying a 3D profile of a molding surface in accordance with the received 2D code pattern. Each of the cells has a corresponding area on the molding surface, where each area has a width dimension “W,” such as 169 microns. The marking includes forming one or more isolated marks within certain of the areas, where such marks have a maximum dimension “D” that is smaller than W/3.

Again, in variant implementations the width dimension is larger or smaller than 169 microns. In further variant implementations, the dimension D is 50, 35, or 25 microns or less.

A further aspect of the technology is a mold having a surface that is marked as just-described.

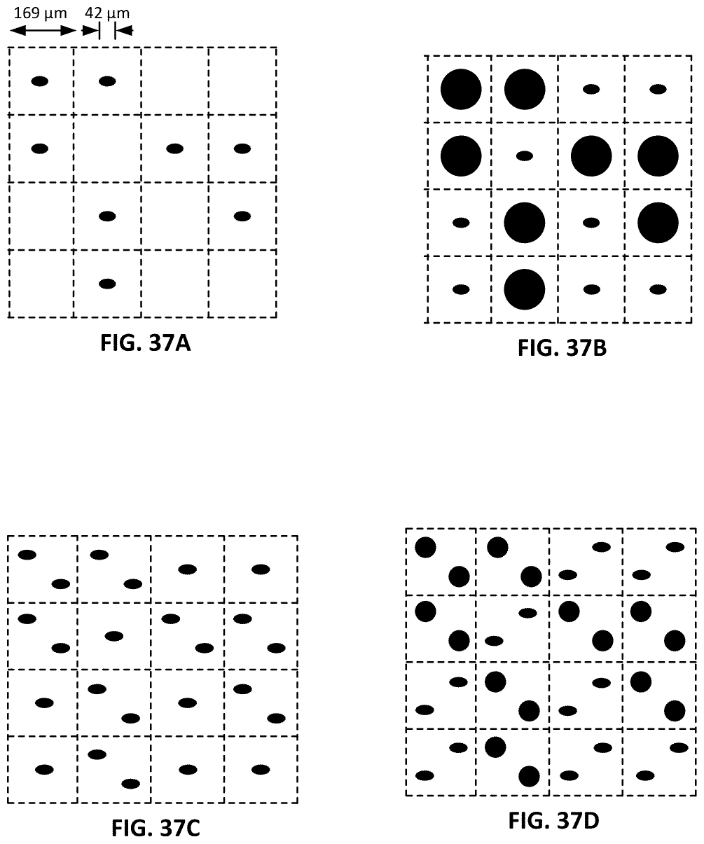

FIG. 37A depicts a 4×4 cell fragment of a 128×128 cell 2D code, as may be formed by depressions in a mold, and then on a plastic object to yield corresponding code protrusions. The code is organized as a grid of cell areas arranged in orthogonal rows and columns. Each cell here represents one waxel of information. Each cell area is 169 microns in width, and the depicted black marks have maximum dimensions across the surface of 42 microns. Thus, in this example, the code includes marks whose dimensions are less than one-third the dimensions of the cells with which they are associated. The vertical extents of the marks—into the mold or protruding from the plastic surface, is typically smaller, such as 20, 5 or 2 microns or less. The marks here are elongated (e.g., into ellipses or ovals), due to movement of the laser beam while marking. In this example, certain cells contain a single mark, while other cells contain no mark.

FIG. 37B shows a variant that expresses a similar pattern of lighter and darker cells. Here, however, the lighter cells include one mark, and the darker cells include a larger mark. FIG. 37C shows a further variant, again expressing a similar pattern. In FIG. 37C the lighter cells contain N marks (here N=1), and the darker cells contain M marks (here M=2), where M>N≥1. FIG. 37D shows a still further variant, in which all cells contain plural marks, but different cells contain marks of different sizes to achieve lighter or darker effects. Of course, countless such variations are possible.

Thus, one embodiment of the technology takes the form of a mold whose surface is shaped to impart a fixed 2D code to a plastic item molded thereby. The 2D code comprises a 2D array of equal-area cells that spans at least part of the mold surface. At least some cells in the array are marked by a depression in the surface, so that the cells define a 2D code pattern. This mold surface has a top surface level that extends in two lateral directions. The depressions extend in a depth direction perpendicular to these two lateral directions. This embodiment is characterised in that at least certain of the depressions have a lateral area that is less than 10% of the area of a cell. The embodiment is further characterized in that (a) the mold surface has a first surface roughness, outside of the depressions, of less than 2 microns, and preferably less than 1, 0.4, 0.1, 0.05 or 0.02 microns, and (b) the mold surface has a second surface roughness, within the depressions, that is at least 1.5 times the first surface roughness and preferably at least 2, 5, 10 or 20 times the first surface roughness.

The cells in this illustrative embodiment are each 169 microns on a side, with an area of 28,561 square microns, so depressions (marks) with less than 10% of this area have areas of less than 2,856 square microns. If the depressions are circular, this corresponds to depressions with diameters of about 43 microns.

As indicated, the marks can be smaller than this. For example, they can be less than 40, 30, 24, or 19 microns in diameter, which correspond to areas less than about 2500, 1400, 900 or 570 square microns. These figures correspond to depressions having areas less than 9%, 5%, 3% or 2% of a cell area. Yet despite these small sizes, the 2D code thereby formed can be detected with a camera having a resolution of a single pixel per cell.

The specified difference between the first and second surface roughnesses enables detection of the 2D code by an imaging system that has a resolution of just one pixel per cell, despite certain of the depressions having lateral areas that are less than 10% (or much less) of a cell area.

Depressions having areas less than 10% of a cell area are beneficial in several respects.

One is that the small aggregate area dedicated to the depressions speeds mold fabrication, since small marks (e.g., 50 microns or less) are quickly made by a laser—especially if their depths are minimal (e.g., less than 10 microns). This is particularly so if their depths are less than 5, 2 or 1 microns.

These small areas are also advantageous because, when the mold is used to produce plastic consumer packing (e.g., shampoo and milk bottles), the resulting small protrusions are found to escape visual and tactile notice by consumers. Thus, existing packaging can be upgraded to include 2D codes without impairing familiar customer experiences of look and feel.

These small areas are particularly important in clear plastic. In clear plastic, such marks—in the aggregate—can “cloud” the apparent crystal clarity of the plastic. By reducing the aggregate percentage of the coded plastic area devoted to the marks, by making each mark small (e.g., 50 microns or less), this clouding effect can be limited. In a particularly preferred embodiment (shown in FIG. 37A), about half of the cells are unmarked, and the remaining cells contain only a single, small mark (i.e., occupying less than 10% or 5% of the cell area). By this arrangement, less than 5% or 2.5% of the total coded area is devoted to marks, essentially preserving 95% or 97.5% of the crystal clarity of clear plastic.

(Note that it is not required for each cell to be marked with only one or no mark. The required number of marks per cell is typically set empirically, based on the application requirements. For example, if the usage scenario includes sorting of soiled plastic waste, it can be desirable to have multiple marks per cell—to aid in code detection in these adverse conditions. The noted benefits come from having small marks, regardless of their absolute number.)

The disparity in surface roughness between the top surface level and the depression, i.e., by a factor of at least 1.5 and more preferably by a factor of 2 or 5 or more, also provides advantages. One is the noted reflection of incident light on the top surface versus the scattering of incident light from the depression surface—aiding code detection. Moreover, the speed and laser power of laser milling is typically moderated to achieve a fine, relatively-smooth finish in the etched areas. Here, a rough finish is acceptable (and is often desirable), meaning that the etching can be conducted at higher laser powers and travel speeds than are often used—speeding mold production.

As noted, some cells can include depressions of one size, while other cells can include depressions of a different size (e.g., as shown in FIG. 37B). Likewise, cells can have depressions of different shapes or depths. And cells can have different numbers of depressions. For instance, one cell can have N depressions and another can have M depressions, where M>N. (In some embodiments, N is at least 1; in other embodiments, N can be zero.) Cells can also have depressions that vary in their surface roughness. Some depressions can have a roughness that is 1.5 times the roughness of the top surface level (i.e., the smooth mold surface), while other depressions can have a roughness that is 2, 5, 10, 20 or more times the roughness of the top surface level.

Such a mold can be of unitary construction (typically of metal), or it can be a rigid body in which metal, ceramic or resin inserts are mounted for customization.

Although an earlier discussion of continuous tone watermarks focused on using different densities of marks within each cell to express different watermark tones, in other embodiments different watermark tones can be expressed by different depths of marks. Thus, in a continuous tone watermark comprised of values between 0 and 255, a value of 255 may be expressed by one or more marks having a depth of 255 microns, a value of 80 may be expressed by one or more marks with a depth of 80 microns, etc. More typically, less-fine quantization is used (often with less-deep etching), such as values in the range 224-255 being expressed by a mark formed to a first depth (e.g., 8 microns), values in the range 192-231 being expressed by a mark formed to a second depth (e.g., 7 microns), and so on.

In many embodiments, a mold shaped with a pattern as described herein is anodized before use. This process applies a thin layer of a more durable material, to extend useful life of the mold. Anodizing can also reduce surface roughness.

As illustrated by the above-detailed arrangements, it will be understood that the markings formed on the mold (and data corresponding thereto) can express a 2D machine readable code hosted within text, a logo, a natural texture pattern, or a man-designed texture pattern. Similarly, such markings (and data corresponding thereto) can express a 2D machine readable code without also expressing text, a logo, a natural texture pattern, or a man-designed texture pattern. In the latter case, the code signal is not obscured or hidden by the presence of other host data. Yet its scale is typically so small that the code signal appears as a random matte surface texture upon human visual inspection.

As noted, a laser is typically used to mark or mill a mold surface (i.e., to vary its 3D profile). But other marking techniques can also be employed (although usually with a loss of speed). These include chemical etching, spark erosion (electrical discharge machining), and mechanical tooling (e.g., by applying a scribing tool, such as a diamond- or carbide metal-tipped instrument, to the mold surface). All are regarded as performing milling operations, and surfaces resulting from each of these techniques are regarded as milled surfaces.

Laser systems suitable for performing the marking described herein are available, e.g., from GF Machining Solutions (a division of Georg Fisher, AG; such systems are commonly marketed under the AgieCharmilles brand). Examples include LASER P 400, LASER S 1000U and Form S 35 systems. Ytterbium pulsed lasers are employed, e.g., with powers of 30, 50 or 100 watts. As noted, femtosecond pulses may be employed for marking.

As is familiar, the mark formed by a laser on a surface is a function of many variables. The larger the area illuminated by the laser, the larger will be the area of the resulting mark. The power of the laser, its wavelength, its cross-sectional energy profile, and the time interval that the laser illuminates a surface location, determine the degree to which the illuminated area will be changed by the laser. A low power, or a brief exposure, warms the metal surface enough to briefly melt it; as it cools it takes on a different finish. Increased exposure leads to boiling of the metal, forming a tortured surface that freezes into place when cooled. Further exposure vaporizes the metal, removing material from the surface, with an uneven boundary surface left behind. The longer such vaporization continues, the deeper the resultant 3D cavity.

(Some artisans draw distinctions between laser etching, laser engraving, laser ablation, etc. All such terms are regarded as synonymous herein, and encompassed by the term laser marking.)

Artisans will understand that injection molding differs from, e.g., thermoforming, in various respects. Thermoforming, for example, commonly starts with a sheet of plastic; injection molding starts with pellets. Thermoforming employs pressures below 200 PSI (often below 50 PSI); injection molding is commonly done at about hundred times greater pressure.

The materials that can be injection molded are virtually limitless. Most common are thermoplastic and thermosetting polymers, but metals, glasses and elastomers can also be so-shaped. Popular plastics for injection molding include high-density polyethylene (HDPE), low-density polyethylene (LDPE), acrylonitrile butadiene styrene (ABS), polycarbonate (PC), polyethylene terephthalate (PET), polypropylene (PP) and polystyrene (PS). Some such plastics can be transparent—either clear or colored. A texture pattern formed on one surface of a molded transparent item can often be read from the other side as well, through the plastic (from the back). Other such plastics are opaque.

The use of injection molding to produce screw-on bottle caps was noted, but the use of injection molding among grocery items extends to components of multiple consumer packaged goods. Examples include various dairy containers and lids, which are often molded with in mold labeling (IML). In IML, a film of printed polypropylene, a few mils in thickness, is inserted into the mold before injection of the hot plastic. The film is adhered to the plastic by the heat and pressure of the molding operation, and the pressure shapes the composite item (with any texture present on the mold surface) to produce a finished item with a printed label already in place. Such food packaging components convey 2D codes in their surface texturing.

This specification particularly noted use of coding on plastic parts to identify such parts for recycling (e.g., based on plastic composition). It will be recognized, however, that such markings can be used whenever an item is to be identified. In some instances, a coded marking is applied to high value parts (e.g., for aerospace applications), for authentication and anti-counterfeiting purposes. Desirably, such marking is done at very fine resolution so that counterfeit parts with such markings cannot be produced without very expensive equipment, which is a deterrent to most counterfeiters. (The same philosophy drives banknote printers to employ extremely high-resolution printing presses.) Thus, for example, a watermark pattern comprised of cells of 50 or 25 microns or less (e.g., 500 or 1000 waxel per inch patterns) formed on an industrial part, with fidelity sufficient to be readable from that part, may require a seven figure investment in suitable laser marking and injection molding systems. (The quality of the mark can be assessed by noting “raw bit” errors, i.e., the fidelity with which the cells of the mark correctly read by a reader without application of the usual error correction capabilities of, e.g., convolutional coding. See the earlier discussion about robustness metrics.)

Although injection molding has been the focus of the specification, it will be recognized that the above teachings can be applied otherwise, e.g., in plastic thermoforming, and in marking metal parts (e.g., direct part marking) without subsequent use of the marked metal in an injection mold. Similarly, the teachings concerning style transfer—including the avoidance of edge discontinuities—can be applied elsewhere, such as in creating stylized 2D artwork for printing on objects or their labels.

While one detailed implementation of style transfer uses a network based on the teachings of Gatys, other implementations can employ different style transfer networks, including the one by Johnson.

Johnson and Gatys differ in that, during a setup phase, Johnson trains the network to extract style data from a style image for later application to a content image. This training is an iterative (gradient descent) process that can take minute or hours, depending on the hardware used. But once the network is trained, different input images can be input and stylized near-instantly, since the trained network simply applies a set of coefficients and weights determined during the setup phase to the input imagery. Gatys is different in that there is no setup phase. Each time the network is used, two sets of input imagery are applied: the style data and the content data. An iterative process then begins that extracts the style information from the former information, and applies it to the content information. If the same style is to be thereafter applied to a different content image, the full (lengthy) process begins anew.

For purposes of this patent application, a watermark is a 2D code produced through a process that represents a message of N symbols using K output symbols, where the ratio N/K is less than 0.2. (In convolutional coding terms, this is the base rate, where smaller rates indicate greater redundancy and thus greater robustness in conveying information through noisy “channels”). In preferred embodiments the ratio N/K is 0.1 or less. Due to the small base rate, a payload can be decoded from a watermark even if half of more (commonly three-quarters or more) or the code is missing.

In an exemplary embodiment, 47 payload bits are concatenated with 24 CRC bits, and these 71 bits (“N”) are convolutionally encoded at a base rate of 1/13 to yield 924 bits (“K”). A further 100 bits of version data are appended to indicate version information, yielding 1024 bits (which are then scrambled and spread to yield the 16,384 values in a 128×128 continuous tone watermark).

Some other 2D codes make use of error correction, but not to such a degree. A QR code, for example, encoded with the highest possible error correction level, can recover from only 30% loss of the code.

Preferred watermark embodiments are also characterized by a synchronization (reference) signal component that is expressed where message data is also expressed. For example, every mark in a sparse watermark is typically a function of the synchronization signal. Again in contrast, synchronization in QR codes is achieved by alignment patterns placed at three corners and at certain intermediate cells. Message data is expressed at none of these locations.

U.S. patent documents teaching watermark encoding and decoding arrangements include U.S. Pat. Nos. 6,590,996, 7,483,547, 9,959,587, 10,217,182, 10,242,434, 10,506,128, 20180005343, 20190332840, and application Ser. No. 16/849,288, filed Apr. 15, 2020, and Ser. No. 16/994,251, filed Aug. 14, 2020,

In addition to teaching watermark encoding and decoding arrangements, the following U.S. patent publications also focus on recycling applications of watermark technology: 20190306385, WO2020186234, 20210299706, and U.S. patent application Ser. No. 16/944,136, filed Jul. 30, 2020, and Ser. No. 17/721,694, filed Apr. 15, 2022.

In addition to teaching watermark encoding and decoding arrangements, the following U.S. patent documents also focus on 3D shaping of physical items to convey watermarks: 20150016664, 20210387399, 20210390358, 63/287,289, filed Dec. 8, 2021, and 63/267,268, filed Jan. 28, 2022.

Mold materials other than metal can also be marked by the methods detailed herein. Examples include ceramics and reinforced resins. In some processes, a metal mold defines the gross shape of an item, and the fine, surface finish of the item is defined by an insert within the mold that may be formed of a material such as a ceramic- or metal reinforced resin and that is shaped in accordance with the above-detailed methods. The insert can be removable to permit different finishes to be applied, without changing the metal mold. Particular arrangements are detailed in above-cited applications 17/721,694 and 63/267,268, as well as in patent publications WO2021124581, JP2001062842A, U.S. Pat. Nos. 9,434,094, 9,174,365 and 8,794,951.

It will be understood that the methods and algorithms detailed above can be executed using computer devices employing one or more processors, one or more memories (e.g. RAM), storage (e.g., a disk or flash memory), a user interface (which may include, e.g., a keypad, a TFT LCD or OLED display screen, touch or other gesture sensors, together with software instructions for providing a graphical user interface), interconnections between these elements (e.g., buses), and a wired or wireless interface for communicating with other devices.

The processes and system components detailed in this specification can be implemented as instructions for computing devices, including general purpose processor instructions for a variety of programmable processors, such as microprocessors and systems on a chip (e.g., the Intel Atom and i9 series, the ARM A8 and Cortex series, the Qualcomm Snapdragon, and the nVidia Tegra 4). Implementation can also employ a variety of specialized processors, such as graphics processing units (GPUs, such as are included in the nVidia Tegra series, and the Adreno 530—part of the Qualcomm Snapdragon processor), and digital signal processors (e.g., the Texas Instruments TMS320 and OMAP series devices, and the ultra-low power Qualcomm Hexagon devices, such as the QDSP6V5A), etc. These instructions can be implemented as software, firmware, etc. These instructions can also be implemented in various forms of processor circuitry, including programmable logic devices, field programmable gate arrays (e.g., the Xilinx Virtex series devices), field programmable object arrays, and application specific circuits —including digital, analog and mixed analog/digital circuitry. Execution of the instructions can be distributed among processors and/or made parallel across processors within a device or across a network of devices. Processing of data can also be distributed among different processor and memory devices. Cloud computing resources can be used as well. References to “processors,” “modules” or “components” should be understood to refer to functionality, rather than requiring a particular form of implementation.

Implementation can additionally, or alternatively, employ special purpose electronic circuitry that has been custom-designed and manufactured to perform some or all of the component acts, as an application specific integrated circuit (ASIC).

Software instructions for implementing the detailed functionality can be authored by artisans without undue experimentation from the descriptions provided herein, e.g., written in C, C++, Visual Basic, Java, Python, Tcl, Perl, Scheme, Ruby, etc., in conjunction with associated data.

Software and hardware configuration data/instructions are commonly stored as instructions in one or more data structures conveyed by tangible media, such as magnetic or optical discs, memory cards, ROM, etc., which may be accessed across a network. Some embodiments may be implemented as embedded systems—special purpose computer systems in which operating system software and application software are indistinguishable to the user (e.g., as is commonly the case in basic cell phones). The functionality detailed in this specification can be implemented in operating system software, application software and/or as embedded system software.

Different of the functionality can be implemented on different devices. Different tasks can be performed exclusively by one device or another, or execution can be distributed between devices. In like fashion, description of data being stored on a particular device is also exemplary; data can be stored anywhere: local device, remote device, in the cloud, distributed, etc.

This specification has discussed various embodiments. It should be understood that the methods, elements and concepts detailed in connection with one embodiment can be combined with the methods, elements and concepts detailed in connection with other embodiments. While some such arrangements have been particularly described, many have not—due to the number of permutations and combinations. Applicant similarly recognizes and intends that the methods, elements and concepts of this specification can be combined, substituted and interchanged—not just among and between themselves, but also with those known from the cited prior art. Moreover, it will be recognized that the detailed technology can be included with other technologies—current and upcoming—to advantageous effect. Implementation of such combinations is straightforward to the artisan from the teachings provided in this disclosure.

While this disclosure has detailed particular ordering of acts and particular combinations of elements, it will be recognized that other contemplated methods may re-order acts (possibly omitting some and adding others), and other contemplated combinations may omit some elements and add others, etc.

Although disclosed as complete systems, sub-combinations of the detailed arrangements are also separately contemplated (e.g., omitting various of the features of a complete system).

While certain aspects of the technology have been described by reference to illustrative methods, it will be recognized that apparatuses configured to perform the acts of such methods are also contemplated as part of applicant's inventive work. Likewise, other aspects have been described by reference to illustrative apparatus, and the methodology performed by such apparatus is likewise within the scope of the present technology. Still further, tangible computer readable media containing instructions for configuring a processor or other programmable system to perform such methods is also expressly contemplated.

To provide a comprehensive disclosure, while complying with the Patent Act's requirement of conciseness, applicant incorporates-by-reference each of the documents referenced herein. (Such materials are incorporated in their entireties, even if cited above in connection with specific of their teachings.) These references disclose technologies and teachings that applicant intends be incorporated into the arrangements detailed herein, and into which the technologies and teachings presently-detailed be incorporated.

In view of the wide variety of embodiments to which the principles and features discussed above can be applied, it should be apparent that the detailed embodiments are illustrative only, and should not be taken as limiting the scope of the technology.

1. A mold including a surface shaped to impart a 2D code to a plastic item molded thereby, the 2D code comprising a 2D array of equal-area cells that spans at least part of said mold surface, at least some cells in said array being marked by a depression in said surface to thereby define a 2D code pattern, the mold surface defining a top surface level that extends in two lateral directions, said depressions extending in a depth direction perpendicular to said two lateral directions, characterised in that: (a) at least certain of said depressions have a lateral area that is less than 10% of the area of a cell; (b) said mold surface has a first surface roughness, outside said depressions, of less than 2 microns and preferably less than 1, 0.4, 0.1, 0.05 or 0.02 microns; and (c) said mold surface has a second surface roughness, within said depressions, that is at least 1.5 times said first surface roughness and preferably at least 2, 5, 10 or 20 times said first surface roughness.

2. The mold of claim 1 in which every cell is marked with at least one depression.

3. The mold of claim 1 in which multiple cells each includes one or more depressions, and each of said depressions in a cell is defined, in part, by a closed boundary within the cell where the depression meets the top surface level of the mold surface.

4. The mold of claim 1 in which one of said cells includes an elongated depression, and another of said cells includes no depression.

5. The mold of claim 1 in which at least certain of said depressions have a lateral area that is less than 5% of the area of a cell.

6. The mold of claim 1 in which at least certain of said depressions have a lateral area that is less than 2% of the area of a cell.

7. The mold of claim 1 in which one of said cells includes a depression of a first size, and another of said cells includes a depression of a second size different than the first size.

8. The mold of claim 1 in which one of said cells includes a depression of a first shape, and another of said cells includes a depression of a second shape different than the first shape.

9. The mold of claim 1 in which one of said cells includes N depressions, and another of said cells includes M depressions, where M>N.

10. The mold of claim 9 in which N is at least 1.

11. The mold of claim 1 in which said depressions include a first depression of a first size and a second depression of a second size different than the first size.

12. The mold of claim 1 in which said depressions include a first depression of a first shape and a second depression of a second shape different than the first shape.

13. The mold of claim 1 in which said depressions include a first depression of a first depth and a second depression of a second depth different than the first depth.

14. The mold of claim 1 in which at least certain of said depressions have depths of less than one micron.

15. The mold of claim 1 in which at least certain of said depressions have lateral areas of less than 2500 square microns.

16. A plastic item molded by the mold of claim 1.

17-39. (canceled)

40. A method comprising the acts:
receiving data expressing a 2D machine readable code, including cells marked in at least first and second different states, each cell having a width dimension less than 500 microns; and
laser marking a metal surface with a pattern corresponding to said 2D machine readable code, each cell of said code having a counterpart area on the metal surface;
wherein a first area corresponding to a single cell of the first state is marked with multiple features.

41-46. (canceled)

47. The method of claim 40 in which the received data expresses the 2D machine readable code within data depicting text or a logo.

48-58. (canceled)

59. A method comprising the acts:
receiving first data defining a texture pattern;
receiving second data depicting a 2D code;
applying a style of the first data to a content of the second data, using a style transfer network, yielding output data having different values; and
milling a mold surface to different depths in accordance with said different values of the output data.

60-62. (canceled)

63. The method of claim 59 in which the first data defines a leather pattern.
